(19) United States
(12) Patent Application Publication
(10) Pub. No.: US 2026/0167833 A1
(43) Pub. Date: Jun. 18, 2026

(54) POLYMER DISPERSANTS, DISPERSANT CONCENTRATES, CONDUCTIVE CARBON DISPERSIONS, AND ELECTRODE SLURRY COMPOSITIONS, AND METHODS OF MAKING AND USE THEREOF

(71) Applicant: Infineum International Limited, Linden, NJ (US)

(72) Inventors: Gang Hu, Scotch Plains, NJ (US); Audrey Tong, Springfield, NJ (US); Daniel Phillips, Southam (GB); James Beament, Wantage (GB)

(73) Assignee: Infineum International Limited, Linden, NJ (US)

(21) Appl. No.: 19/417,806

(22) Filed: Dec. 12, 2025

Related U.S. Application Data
(60) Provisional application No. 63/733,540, filed on Dec. 13, 2024.

(51) Int. Cl. C09D 7/45; C08F 20/18; C09D 5/24; C09D 7/20; C09D 7/61; C09D 7/65; H01G 11/28; H01G 11/32; H01M 4/02; H01M 4/136; H01M 4/62

(52) U.S. Cl. CPC C09D 7/45; C08F 20/18; C09D 5/24; C09D 7/20; C09D 7/61; C09D 7/65; H01G 11/28; H01G 11/32; H01M 4/136; H01M 4/62; H01M 4/623; H01M 4/625; H01M 2004/021; H01M 2004/028

(57) ABSTRACT

Copolymers having structural units of the residue of a substituted or unsubstituted, unsaturated organic nitrile monomer present in an amount from about 1 wt % to about 55 wt %, based on the total weight of the copolymer; and structural units of the residue of a substituted or unsubstituted, unsaturated, conjugated aromatic monomer selected from a conjugated aromatic ester monomer, a conjugated aromatic ether monomer, a conjugated aromatic amide monomer, a conjugated aromatic alkylene monomer, and combinations thereof, present in an amount from about 45 wt % to about 99 wt %, based on the total weight of the copolymer. Homopolymers and copolymers that are useful as dispersants. Dispersant concentrates, conductive carbon dispersions, electrode slurry compositions, positive electrodes, and electrical storage devices, using the dispersants. The dispersants are used in conductive carbon dispersions and electrode slurry compositions to achieve low viscosity at high solids content.

### CROSS-REFERENCE TO RELATED APPLICATION

This U.S. Non-provisional application claims priority to U.S. Provisional Application Ser. No. 63/733,540 filed on Dec. 13, 2024, the contents of which are herein incorporated by reference in their entirety.

### FIELD

This disclosure relates to homopolymers and copolymers that are useful as dispersants. This disclosure also relates to dispersant concentrates, conductive carbon dispersions, and electrode slurry compositions. This disclosure further relates to positive electrodes, and electrical storage devices that use the electrode slurry compositions disclosed herein.

### BACKGROUND

A secondary battery is a battery which may be repeatedly used through a discharging process in which chemical energy is converted into electrical energy and a charging process in the reverse direction thereof. The secondary battery is composed of a positive electrode, a negative electrode, an electrolyte, and a separator. In general, the positive electrode and the negative electrode are composed of an electrode current collector and an electrode active material layer formed on the electrode current collector. The electrode active material layer is prepared by applying an electrode slurry composition including an electrode active material, a conductive material, a binder, a solvent, and the like on the electrode current collector, followed by drying, and then roll-pressing.

The manufacturing process for a secondary lithium-ion battery (LiB) cathode requires casting a cathode slurry uniformly onto a metal current collector (typically aluminum sheet) as the first step. Cathode slurry is typically a composition of battery active materials (AM), conductive carbon (CC), and binder (polyvinylidene fluoride, PVDF), mixed in solvent (typically N-methyl pyrrolidone, NMP). To achieve high battery capacity and long cycling life, it is critical to ensure that AM and CC agglomerates in raw materials are broken down into small particles uniformly, and stably dispersed in cathode slurry with desired rheological properties for coating.

To that end, a wetting and dispersing agent is added in the composition to expediate and stabilize the dispersion of AM and CC in cathode slurry, and thus achieve desired physical properties. Moreover, as the solvent NMP is evaporated and removed under heat and vacuum, and then recycled immediately after coating, high-solid content (total of non-volatiles), or less-solvent slurry is highly desired (like 65 wt %) to reduce cycle time and operational cost. Therefore, there is a great need in the battery industry to achieve a high-solid content slurry while still maintain desired dispersion and rheological properties.

On the other hand, carbon nanotubes (CNTs) are replacing carbon black (CB) as conductive carbon in cathode composition to improve electrode conductivity among AM particles, due to CNT's very high aspect ratio (length/diameter ratio). However, also due to the high aspect ratio, CNTs are very difficult to disperse in a medium, especially at high CNT treat rate. Usually, CNTs are pre-dispersed in a solvent to form CNT dispersion which is then mixed with other components of cathode composition to form cathode slurry. In that process, a wetting and dispersing agent can also be added to aid and stabilize CNT dispersion in NMP, ideally at a high CNT content.

Polyvinylpyrrolidone (PVP) is widely used as a dispersant, and recognized as an industry benchmark dispersant. However, PVP suffers from low dispersing efficiency and side reactions of decomposition in battery operation, especially at high voltage. Additionally, the viscosity of a conductive material dispersion using a PVP dispersant increases rapidly when the content of a conductive material increases and with prolonged storage time. So there is a limit to increasing the content of the conductive material or active material.

It would be advantageous to provide dispersants that are more electrochemically stable and more efficient than the industry benchmark PVP dispersant. Also, it would be advantageous to provide dispersants that achieve lower viscosity of a CNT dispersion, or a cathode slurry composition, than viscosity achieved with the industry benchmark PVP dispersant, or increase solid content of the CNT dispersion or cathode slurry composition. Further, it would be advantageous to provide dispersants that are capable of wetting and dispersing CNTs in a medium (e.g., NMP), especially at a high CNT treatment rate, as well as active materials, such as for example, lithium iron phosphate (LFP) in cathode slurries of NMP.

### SUMMARY

In accordance with an aspect of the present disclosure, there is provided a class of copolymer and homopolymer dispersants that are more stable and more efficient than the industry benchmark PVP dispersant. The copolymer and homopolymer dispersants of this disclosure achieve lower viscosity of a CNT dispersion, or a cathode slurry composition, than viscosity achieved with the industry benchmark PVP dispersant, or increase solid content of the CNT dispersion or cathode slurry composition. The copolymer and homopolymer dispersants of this disclosure are capable of wetting and dispersing CNTs in a medium (e.g., NMP), especially a high CNT treatment rate, as well as lithium iron phosphate (LFP) active materials in cathode slurries of NMP suitable for use as dispersants, which can effectively wet and disperse CNTs in NMP, as well as lithium iron phosphate (LFP) active materials in cathode slurries of NMP.

The copolymers of the present disclosure useful as dispersants have structural units comprising the residue of a substituted or unsubstituted, unsaturated organic nitrile monomer; and structural units comprising the residue of a substituted or unsubstituted, unsaturated, conjugated aromatic monomer selected from the group consisting of a conjugated aromatic ester monomer, a conjugated aromatic ether monomer, a conjugated aromatic amide monomer, a conjugated aromatic alkylene monomer, and combinations thereof. The structural units comprising the residue of a substituted or unsubstituted, unsaturated, conjugated aromatic monomer are present in an amount from about 45 to about 99 wt %, and the structural units comprising the residue of the substituted or unsubstituted, unsaturated organic nitrile monomer are present in an amount from about 1 to about 55 wt %, based on the total weight of the copolymer.

The homopolymers of the present disclosure useful as dispersants have structural units represented by the formula:

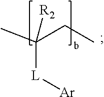

or by the formula

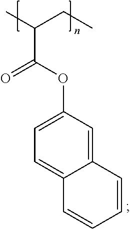

or by the formula:

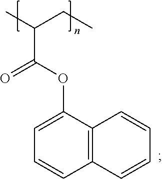

wherein R₂ is hydrogen or an alkyl group having from 1 to 10 carbon atoms; L is a linkage group selected from the group consisting of an ester linkage group, an ether linkage group, an amide linkage group, an alkylene linkage group, and any combination thereof, Ar is a substituted or unsubstituted conjugated aromatic group having at least 1 aromatic ring; and b and n are independently a value from about 10 to about 400; and wherein the ether linkage group is other than the ether linkage group represented by the formula:

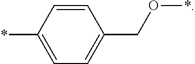

The copolymers and homopolymers of this disclosure are effective as dispersants.

Additionally or alternatively, the present disclosure provides a dispersant concentrate comprising a copolymer or homopolymer dispersant, and a solvent.

Additionally or alternatively, the present disclosure provides a conductive carbon dispersion comprising the copolymer or homopolymer dispersant, or the dispersant concentrate, a conductive carbon, and a solvent.

Further additionally or alternatively, the present disclosure provides an electrode slurry composition for producing a battery positive electrode comprising the conductive carbon dispersion, an electrode active material, a binder, and a solvent.

Further additionally or alternatively, the present disclosure provides a positive electrode comprising an electrical current collector and a film formed on the electrical current collector, wherein the film is deposited from the electrode slurry composition, and the solvent subsequently removed.

Further additionally or alternatively, the present disclosure provides an electrical storage device comprising the positive electrode, a negative electrode, a separator, and an electrolyte.

Further additionally or alternatively, the present disclosure provides a process for preparing a neat copolymer. The process comprises mixing in a reaction vessel, with heating and an inert atmosphere, a substituted or unsubstituted, unsaturated organic nitrile monomer, a substituted or unsubstituted, unsaturated, conjugated aromatic monomer, a radical initiator, and a solvent, for a period of time sufficient to form a copolymer; obtaining the copolymer in a solvent as a concentrate; and removing the solvent under vacuum to obtain the neat copolymer. The neat copolymer is effective as a dispersant.

Further additionally or alternatively, the present disclosure provides a process for preparing a neat homopolymer. The process comprises mixing in a reaction vessel, with heating and an inert atmosphere, a substituted or unsubstituted, unsaturated, conjugated aromatic monomer, a radical initiator, and a solvent, for a period of time sufficient to form a homopolymer; obtaining the homopolymer in a solvent as a concentrate; and removing the solvent under vacuum to obtain the neat homopolymer. The neat homopolymer is effective as a dispersant.

It has been surprisingly found that, in accordance with this disclosure, the copolymers and homopolymers are effective dispersants that can be used in a CNT dispersion to achieve lower viscosity of the dispersion than industry benchmark PVP dispersant, and increase solid content of the dispersion, thereby making the CNT dispersion attractive for LiB manufacturers.

It has also been surprisingly found that, in accordance with this disclosure, the copolymer and homopolymer dispersants can be used in LFP cathode slurry formulations to achieve lower viscosity than industry benchmark PVP dispersant at high solid content, thereby making the dispersants attractive for LiB manufacturer's LFP slurry formulations.

### BRIEF DESCRIPTION OF THE DRAWINGS

FIG. 1 graphically depicts a comparison of rheology of the CNT dispersions with different dispersants in Table E, particularly viscosity relative to shear rate for comparative and inventive dispersants in Table E below in CNT dispersions, in accordance with the Examples.

FIG. 2 graphically depicts a comparison of rheology of the LFP cathode slurries with different dispersants in Table F, particularly viscosity relative to shear rate for comparative and inventive dispersants in Table F below in LFP cathode slurries, in accordance with the Examples.

FIG. 3 graphically depict additional plots from FIG. 1 of the viscosity change relative to shear rate with different dispersants in CNT dispersion, particularly relative viscosity change and mean relative viscosity change versus naphthyl acrylate wt % relative to shear rate, in accordance with the Examples.

FIG. 4 graphically depict additional plots from FIG. 2 of the viscosity change relative to shear rate with different dispersants in LFP cathode slurry, particularly viscosity change % versus naphthyl acrylate wt % relative to shear rate, in accordance with the Examples.

### DETAILED DESCRIPTION

The term “about” means approximately, which includes values obtain by rounding. As used herein, the term “about” modifying the quantity of an ingredient, component, or reactant of the invention employed refers to variation in the numerical quantity that can occur, for example, through typical measuring and liquid handling procedures used for making concentrates or lubricating oil compositions. Furthermore, variation can occur from inadvertent error in measuring procedures, differences in the manufacture, source, or purity of the ingredients employed to make the compositions or carry out the methods, and the like. In one aspect, the term “about” means within 10% of the reported numerical value. In another aspect, the term “about” means within 5% of the reported numerical value. Yet, in another aspect, the term “about” means within 10, 9, 8, 7, 6, 5, 4, 3, 2, or 1% of the reported numerical value. All numerical values included in the specification and the claims are understood to be modified by “about” even if such numerical value is not preceded by “about.”

This disclosure is directed to homopolymers and copolymers that are effective as dispersants. This disclosure is also directed to dispersant concentrates, conductive carbon dispersions, electrode slurry compositions, positive electrodes, and electrical storage devices, using the dispersants.

### Copolymers

Copolymers of the present disclosure have structural units comprising the residue of a substituted or unsubstituted, unsaturated organic nitrile monomer; and structural units comprising the residue of a substituted or unsubstituted, unsaturated, conjugated aromatic monomer selected from the group consisting of a conjugated aromatic ester monomer, a conjugated aromatic ether monomer, a conjugated aromatic amide monomer, a conjugated aromatic alkylene monomer, and combinations thereof. The structural units comprising the residue of a substituted or unsubstituted, unsaturated, conjugated aromatic monomer are present in an amount from about 45 to about 99 wt %, and the structural units comprising the residue of the substituted or unsubstituted, unsaturated organic nitrile monomer are present in an amount from about 1 to about 55 wt %, based on the total weight of the copolymer.

The copolymers can be in the form of a block copolymer, a random copolymer, or a gradient copolymer.

In an embodiment, the substituted or unsubstituted, unsaturated organic nitrile monomer is represented by the formula:

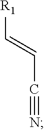

by the formula:

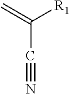

wherein R₁ is hydrogen or an alkyl group having from 1 to 10 carbon atoms. Preferably, R₁ is hydrogen.

In an embodiment, the substituted or unsubstituted, unsaturated, conjugated aromatic monomer is represented by the formula:

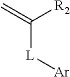

wherein R₂ is hydrogen or an alkyl group having from 1 to 10 carbon atoms; L is a linkage group selected from the group consisting of an ester linkage group, an ether linkage group, an amide linkage group, an alkylene linkage group; and any combination thereof; and Ar is a substituted or unsubstituted conjugated aromatic group having at least 1 aromatic ring. Preferably, R₂ is hydrogen, or an alkyl group having from 1 to 8 carbon atoms, or an alkyl group having from 1 to 6 carbon atoms, or an alkyl group having from 1 to 4 carbon atoms, or an alkyl group having 1 or 2 carbon atoms, or a methyl group.

The ester linkage group is represented by the formula:

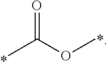

The ether linkage group is represented by the formula selected from the following:

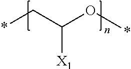

wherein X₁ is hydrogen, or an alkyl group having from 1 to 10 carbon atoms, or an alkyl group having from 1 to 8 carbon atoms, or an alkyl group having from 1 to 6 carbon atoms, or an alkyl group having from 1 to 4 carbon atoms, or an alkyl group having 1 or 2 carbon atoms, or a methyl group; and n is a value from 0 to 24, or a value from 0 to 20, or a value from 0 to 15, or a value from 0 to 10, or a value from 0 to 5;

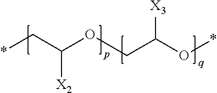

wherein X₂ and X₃ are independently hydrogen or an alkyl group having from 1 to 10 carbon atoms, or an alkyl group having from 1 to 8 carbon atoms, or an alkyl group having from 1 to 6 carbon atoms, or an alkyl group having from 1 to 4 carbon atoms, or an alkyl group having 1 or 2 carbon atoms, or a methyl group; and p and q are independently a value from 0 to 24, or a value from 0 to 20, or a value from 0 to 15, or a value from 0 to 10, or a value from 0 to 5; and any combination thereof. Preferably, n, p, and q are independently a value from 0 to 5; and X₁, X₂, and X₃ are independently hydrogen or methyl;

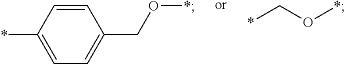

and any combination thereof.

The amide linkage group is represented by the formula selected from the group consisting of:

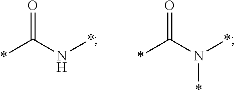

and
a combination thereof.

The alkylene linkage group is represented by the formula:

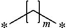

wherein m is a value from 1 to 10, or a value from 1 to 8, or a value from 1 to 6, or a value from 1 to 4, or a value from 1 to 2. Preferably, m is a value of 2.

The Ar substituent is represented by the formula selected from the following:

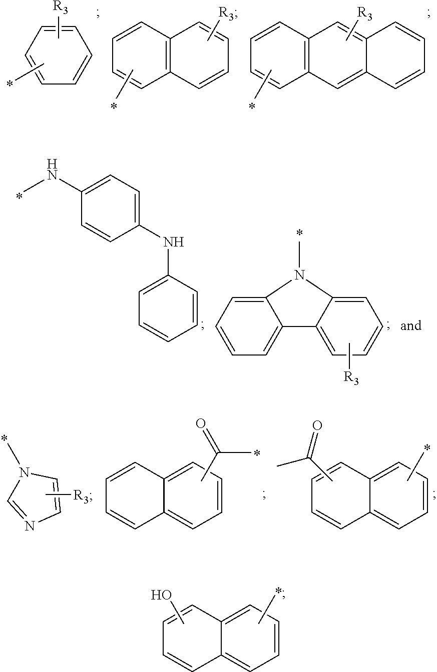

wherein R₃ is hydrogen or an alkyl group having from 1 to 10 carbon atoms, or an alkyl group having from 1 to 8 carbon atoms, or an alkyl group having from 1 to 6 carbon atoms, or an alkyl group having from 1 to 4 carbon atoms, or an alkyl group having 1 or 2 carbon atoms, or a methyl group. Preferably, Ar has at least 2 aromatic rings, or at least 3 aromatic rings, or at least 1 aromatic ring containing nitrogen or oxygen. Preferably, R₃ is hydrogen.

In an embodiment, the copolymer of this disclosure is represented by the formula:

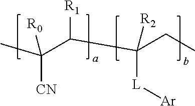

wherein R₀, R₁ and R₂ are independently hydrogen or an alkyl group having from 1 to 10 carbon atoms; L is a linkage group selected from the group consisting of an ester linkage group, an ether linkage group, an amide linkage group, an alkylene linkage group, and any combination thereof, Ar is a substituted or unsubstituted conjugated aromatic group having at least 1 aromatic ring; a is a value from about 10 to about 200; and b is a value from about 10 to about 200.

In an embodiment, the substituted or unsubstituted, unsaturated organic nitrile monomer is acrylonitrile monomer represented by the formula:

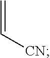

and
the substituted or unsubstituted, unsaturated, conjugated aromatic monomer is 1-napthyl acrylate represented by the formula:

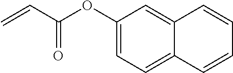

or 1-napthyl acrylate represented by the formula:

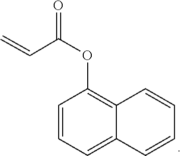

A preferred copolymer of this disclosure is a poly(acrylonitrile 2-napthyl acrylate) (PANA) represented by the formula:

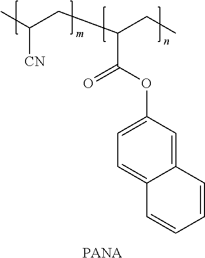

or a poly(acrylonitrile 2-napthyl acrylate) represented by the formula:

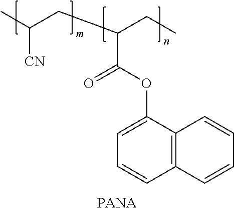

wherein m has a value from 10 to about 200, and n has a value from about 10 to about 200.

In the copolymers of this disclosure, the structural units comprising the residue of the substituted or unsubstituted, unsaturated organic nitrile monomer are present in an amount from about 0.5 wt % to about 55 wt %, 1 wt % to about 50 wt %, or from about 1 wt % to about 45 wt %, or from about 1 wt % to about 40 wt %, or from about 1 wt % to about 35 wt %, or from about 1 wt % to about 30 wt %, or from about 1 wt % to about 25 wt %, or from about 1 wt % to about 20 wt %, or from about 1 wt % to about 15 wt %, or from about 1 wt % to about 10 wt %, or from about 1 wt % to about 5 wt %, based on the total weight of the copolymer.

In the copolymers of this disclosure, the structural units comprising the residue of the substituted or unsubstituted, unsaturated, conjugated aromatic monomer are present in an amount from about 45 wt % to about 99.5 wt %, 50 wt % to about 99 wt %, or from about 55 wt % to about 99 wt %, or from about 60 wt % to about 99 wt %, or from about 65 wt % to about 99 wt %, or from about 70 wt % to about 99 wt %, or from about 75 wt % to about 99 wt %, or from about 80 wt % to about 99 wt %, or from about 85 wt % to about 99 wt %, or from about 90 wt % to about 99 wt %, based on the total weight of the copolymer.

In the copolymers of this disclosure, the weight ratio of the structural units comprising the residue of the substituted or unsubstituted, unsaturated organic nitrile monomer to the structural units comprising the residue of the substituted or unsubstituted, unsaturated, conjugated aromatic monomer in the copolymer is from about 1:99 to about 55:45, or from about 1:99 to about 50:50, or from about 1:99 to about 45:55, or from about 1:99 to about 40:60, or from about 1:99 to about 35:65, or from about 1:99 to about 30:70, or from about 1:99 to about 25:75, or from about 1:99 to about 20:80, or from about 1:99 to about 15:85, or from about 1:99 to about 10:90, or from about 1:99 to about 5:95.

In an embodiment, the copolymers of this disclosure have a glass transition temperature (Tg) of 150° C. or less, preferably a glass transition temperature (Tg) of +50 to +150° C., or +60 to +140° C., or +70 to +130° C., +80 to +120° C., or +90 to +110° C. In another embodiment, the copolymers of this disclosure have a glass transition temperature (Tg) of −50 to +70° C., or −50 to +60° C., or −50 to +50° C., or −50 to +40° C., or −50 to +25° C., or −50 to +20° C., or −50 to +15° C., or −50 to +10° C., or −50 to +5° C., or −50 to 0° C., or −40 to +50° C., or −40 to +40° C., or −40 to +25° C., or −40 to +20° C., or −40 to +15° C., or −40 to +10° C., or −40 to +5° C., or −40 to 0° C., or −30 to +50° C., or −30 to +40° C., or −30 to +25° C., or −30 to +20° C., or −30 to +15° C., or −30 to +10° C., or −30 to +5° C., or −30 to 0° C., or −20 to +50° C., or −20 to +40° C., or −20 to +25° C., or −20 to +20° C., or −20 to +15° C., or −20 to +10° C., or −20 to +5° C., or −20 to 0° C., or −15 to +50° C., or −15 to +40° C., or −15 to +25° C., or −15 to +20° C., or −15 to +15° C., or −15 to +10° C., or −15 to +5° C., or −15 to 0° C., or −10 to +50° C., or −10 to +40° C., or −10 to +25° C., or −10 to +20° C., or −10 to +15° C., or −10 to +10° C., or −10 to +5° C., or −10 to 0° C., or −5 to +50° C., or −5 to +40° C., or −5 to +25° C., or −5 to +20° C., or −5 to +15° C., or −5 to +10° C., or −5 to +5° C., or −5 to 0° C., or −0 to +50° C., or −0 to +40° C., or −0 to +25° C., or −0 to +20° C., or −0 to +15° C.

The copolymers of this disclosure have a weight average molecular weight of at least 2,500 g/mol, or at least 5,000 g/mol, or at least 7,500 g/mol, or least 10,000 g/mol. Preferably, the copolymers of this disclosure have a weight average molecular weight of no more than 400,000 g/mol, or no more than 200,000 g/mol, or no more than 100,000, or no more than 75,000 g/mol, or no more than 50,000 g/mol, or no more than 25,000 g/mol, or no more than 20,000 g/mol, or no more than 15,000 g/mol, or no more than 10,000 g/mol, or no more than 7,500 g/mol.

In an embodiment, the copolymers of this disclosure have a weight average molecular weight of 2,500 to 400,000 g/mol, or 2,500 to 300000 g/mol, or 2,500 to 200,000 g/mol, or 2,500 to 100,000 g/mol, or 2,500 to 75,000 g/mol, or 2,500 to 50,000 g/mol, or 2,500 to 25,500 g/mol, or 2,500 to 10,000 g/mol, or 2.500 to 7,500 g/mol, or 5,000 to 400,000 g/mol, or 5,000 to 300,000 g/mol, or 5,000 to 200,000 g/mol, or 5,000 to 100,000 g/mol, or 5,000 to 75,000 g/mol, or 5,000 to 50,000 g/mol, or 5,000 to 25,000 g/mol, or 5,000 to 12,500 g/mol, or 5,000 to 10,000 g/mol, or 5,000 to 7.500 g/mol, or 7,500 to 400,000 g/mol, or 7,500 to 300,000 g/mol, or 7,500 to 200,000 g/mol, or 7,500 to 100,000 g/mol, or 7,500 to 75,000 g/mol, or 7,500 to 50,000 g/mol, or 7,500 to 25,000 g/mol, or 7,500 to 15,000 g/mol, or 7,500 to 12,500 g/mol, or 7,500 to 10,000 g/mol, or 10,000 to 400,000 g/mol, or 10,000 to 300,000 g/mol, or 10,000 to 200,000 g/mol, or 10,000 to 100,000 g/mol, or 10,000 to 75,000 g/mol, or 10,000 to 50,000 g/mol, or 10,000 to 25,000 g/mol, or 10,000 to 12,500 g/mol.

The copolymers of this disclosure have a number average molecular weight of at least 5,000 g/mol, or at least 10,000 g/mol, or at least 15,000 g/mol, or at least 20,000 g/mol. Preferably, the copolymers of this disclosure have a number average molecular weight of no more than 200,000 g/mol, or no more than 150,000 g/mol, or no more than 100,000 g/mol, or no more than 50,000 g/mol, or no more than 40,000 g/mol, or no more than 30,000 g/mol, or no more than 20,000 g/mol, or no more than 15,000 g/mol.

In an embodiment, the copolymers of this disclosure have a number average molecular weight of 5,000 to 200,000 g/mol, or 5,000 to 150,000 g/mol, or 5,000 to 100,000 g/mol, or 5,000 to 50,000 g/mol, or 5,000 to 40,000 g/mol, or 5,000 to 30,000 g/mol, or 5,000 to 25,000 g/mol, or 5,000 to 20,000 g/mol, or 5,000 to 15,000 g/mol, or 10,000 to 200,000 g/mol, or 10,000 to 150,000 g/mol, or 10,000 to 100,000 g/mol, or 10,000 to 50,000 g/mol, or 10,000 to 40,000 g/mol, or 10,000 to 30,000 g/mol, or 10,000 to 25,000 g/mol, or 10,000 to 20,000 g/mol, or 10,000 to 15,000 g/mol, or 15,000 to 200,000 g/mol, or 15,000 to 150,000 g/mol, or 15,000 to 100,000 g/mol, or 15,000 to 50,000 g/mol, or 15,000 to 40,000 g/mol, or 15,000 to 30,000 g/mol, or 15,000 to 25,000 g/mol, or 15,000 to 20,000 g/mol, or 20,000 to 200,000 g/mol, or 20,000 to 150,000 g/mol, or 20,000 to 100,000 g/mol, or 20,000 to 50,000 g/mol, or 20,000 to 40,000 g/mol, or 20,000 to 30,000 g/mol, or 20,000 to 25,000 g/mol.

### Process for Preparing Copolymers

The copolymers may be prepared by free radical initiated solution polymerization techniques in which the polymerizable monomers are dissolved in an organic medium comprising a solvent or a mixture of solvents and polymerized in the presence of a free radical initiator until conversion is complete. The organic medium used to produce the copolymer may comprise any suitable organic solvent or mixture of solvents, including those discussed herein with respect to the organic medium.

Examples of free radical initiators are those which are soluble in the mixture of monomers such as azobisisobutyronitrile (AIBN), azobis(alpha, gamma-methylvaleronitrile), tertiary-butyl perbenzoate, tertiary-butyl peracetate, benzoyl peroxide, ditertiary-butyl peroxide, and tertiary amyl peroxy 2-ethylhexyl carbonate.

Optionally, a chain transfer agent which is soluble in the mixture of monomers such as alkyl mercaptans, for example, tertiary-dodecyl mercaptan; ketones such as methyl ethyl ketone, chlorohydrocarbons such as chloroform, or thiocarbonyl and nitroxide compounds can be used. A chain transfer agent provides control over the molecular weight to give products having required viscosity for various coating applications.

To prepare the copolymer, the solvent may be first heated to reflux and the mixture of polymerizable monomers containing the free radical initiator may be added slowly to the refluxing solvent. The reaction mixture is then held at polymerizing temperatures so as to reduce the free monomer content, such as to below 1.0 percent and usually below 0.5 percent, based on the total weight of the mixture of polymerizable monomers.

In a preferred embodiment, the process for preparing the copolymers of this disclosure comprises mixing in a reaction vessel, with heating and an inert atmosphere, a substituted or unsubstituted, unsaturated organic nitrile monomer, a substituted or unsubstituted, unsaturated, conjugated aromatic monomer, a radical initiator, and a solvent, for a period of time sufficient to form a copolymer; obtaining the copolymer in a solvent as a concentrate; and removing the solvent under vacuum to obtain the neat copolymer.

### Homopolymers

Homopolymers of the present disclosure, effective as dispersants, can be characterized by the formula:

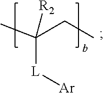

or by the formula

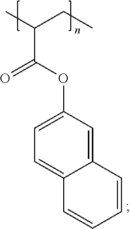

or by the formula:

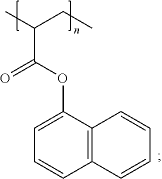

wherein R₂ is hydrogen or an alkyl group having from 1 to 10 carbon atoms; L is a linkage group selected from the group consisting of an ester linkage group, an ether linkage group, an amide linkage group, an alkylene linkage group, and any combination thereof; Ar is a substituted or unsubstituted conjugated aromatic group having at least 1 aromatic ring; and b and n are independently a value from about 10 to about 400; and wherein the ether linkage group is other than the ether linkage group represented by the formula:

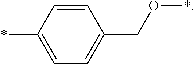

In an embodiment, the homopolymers of this disclosure have a glass transition temperature (Tg) of 150° C. or less, preferably a glass transition temperature (Tg) of +50 to +150° C., or +60 to +140° C., or +70 to +130° C., +80 to +120° C., or +90 to +110° C. In another embodiment, the homopolymers of this disclosure have a glass transition temperature (Tg) of −50 to +70° C., or −50 to +60° C., or −50 to +50° C., or −50 to +40° C., or −50 to +25° C., or −50 to +20° C., or −50 to +15° C., or −50 to +10° C., or −50 to +5° C., or −50 to 0° C., or −40 to +50° C., or −40 to +40° C., or −40 to +25° C., or −40 to +20° C., or −40 to +15° C., or −40 to +10° C., or −40 to +5° C., or −40 to 0° C., or −30 to +50° C., or −30 to +40° C., or −30 to +25° C., or −30 to +20° C., or −30 to +15° C., or −30 to +10° C., or −30 to +5° C., or −30 to 0° C., or −20 to +50° C., or −20 to +40° C., or −20 to +25° C., or −20 to +20° C., or −20 to +15° C., or −20 to +10° C., or −20 to +5° C., or −20 to 0° C., or −15 to +50° C., or −15 to +40° C., or −15 to +25° C., or −15 to +20° C., or −15 to +15° C., or −15 to +10° C., or −15 to +5° C., or −15 to 0° C., or −10 to +50° C., or −10 to +40° C., or −10 to +25° C., or −10 to +20° C., or −10 to +15° C., or −10 to +10° C., or −10 to +5° C., or −10 to 0° C., or −5 to +50° C., or −5 to +40° C., or −5 to +25° C., or −5 to +20° C., or −5 to +15° C., or −5 to +10° C., or −5 to +5° C., or −5 to 0° C., or −0 to +50° C., or −0 to +40° C., or −0 to +25° C., or −0 to +20° C., or −0 to +15° C.

The homopolymers of this disclosure have a weight average molecular weight of at least 2,500 g/mol, or at least 5,000 g/mol, or at least 7,500 g/mol, or least 10,000 g/mol. Preferably, the homopolymers of this disclosure have a weight average molecular weight of no more than 400,000 g/mol, or no more than 200,000 g/mol, or no more than 100,000, or no more than 75,000 g/mol, or no more than 50,000 g/mol, or no more than 25,000 g/mol, or no more than 20,000 g/mol, or no more than 15,000 g/mol, or no more than 10,000 g/mol, or no more than 7,500 g/mol.

In an embodiment, the homopolymers of this disclosure have a weight average molecular weight of 2,500 to 400,000 g/mol, or 2,500 to 300000 g/mol, or 2,500 to 200,000 g/mol, or 2,500 to 100,000 g/mol, or 2,500 to 75,000 g/mol, or 2,500 to 50,000 g/mol, or 2,500 to 25,500 g/mol, or 2,500 to 10,000 g/mol, or 2.500 to 7,500 g/mol, or 5,000 to 400,000 g/mol, or 5,000 to 300,000 g/mol, or 5,000 to 200,000 g/mol, or 5,000 to 100,000 g/mol, or 5,000 to 75,000 g/mol, or 5,000 to 50,000 g/mol, or 5,000 to 25,000 g/mol, or 5,000 to 12,500 g/mol, or 5,000 to 10,000 g/mol, or 5,000 to 7.500 g/mol, or 7,500 to 400,000 g/mol, or 7,500 to 300,000 g/mol, or 7,500 to 200,000 g/mol, or 7,500 to 100,000 g/mol, or 7,500 to 75,000 g/mol, or 7,500 to 50,000 g/mol, or 7,500 to 25,000 g/mol, or 7,500 to 15,000 g/mol, or 7,500 to 12,500 g/mol, or 7,500 to 10,000 g/mol, or 10,000 to 400,000 g/mol, or 10,000 to 300,000 g/mol, or 10,000 to 200,000 g/mol, or 10,000 to 100,000 g/mol, or 10,000 to 75,000 g/mol, or 10,000 to 50,000 g/mol, or 10,000 to 25,000 g/mol, or 10,000 to 12,500 g/mol.

The homopolymers of this disclosure have a number average molecular weight of at least 5,000 g/mol, or at least 10,000 g/mol, or at least 15,000 g/mol, or at least 20,000 g/mol. Preferably, the homopolymers of this disclosure have a number average molecular weight of no more than 200,000 g/mol, or no more than 150,000 g/mol, or no more than 100,000 g/mol, or no more than 50,000 g/mol, or no more than 40,000 g/mol, or no more than 30,000 g/mol, or no more than 20,000 g/mol, or no more than 15,000 g/mol.

In an embodiment, the homopolymers of this disclosure have a number average molecular weight of 5,000 to 200,000 g/mol, or 5,000 to 150,000 g/mol, or 5,000 to 100,000 g/mol, or 5,000 to 50,000 g/mol, or 5,000 to 40,000 g/mol, or 5,000 to 30,000 g/mol, or 5,000 to 25,000 g/mol, or 5,000 to 20,000 g/mol, or 5,000 to 15,000 g/mol, or 10,000 to 200,000 g/mol, or 10,000 to 150,000 g/mol, or 10,000 to 100,000 g/mol, or 10,000 to 50,000 g/mol, or 10,000 to 40,000 g/mol, or 10,000 to 30,000 g/mol, or 10,000 to 25,000 g/mol, or 10,000 to 20,000 g/mol, or 10,000 to 15,000 g/mol, or 15,000 to 200,000 g/mol, or 15,000 to 150,000 g/mol, or 15,000 to 100,000 g/mol, or 15,000 to 50,000 g/mol, or 15,000 to 40,000 g/mol, or 15,000 to 30,000 g/mol, or 15,000 to 25,000 g/mol, or 15,000 to 20,000 g/mol, or 20,000 to 200,000 g/mol, or 20,000 to 150,000 g/mol, or 20,000 to 100,000 g/mol, or 20,000 to 50,000 g/mol, or 20,000 to 40,000 g/mol, or 20,000 to 30,000 g/mol, or 20,000 to 25,000 g/mol.

### Process for Preparing Homopolymers

The homopolymers may be prepared by free radical initiated solution polymerization techniques in which the polymerizable monomer is dissolved in an organic medium comprising a solvent or a mixture of solvents and polymerized in the presence of a free radical initiator until conversion is complete. The organic medium used to produce the homopolymer may comprise any suitable organic solvent or mixture of solvents, including those discussed herein with respect to the organic medium.

Examples of free radical initiators are those which are soluble in the mixture of monomers such as azobisisobutyronitrile (AIBN), azobis(alpha, gamma-methylvaleronitrile), tertiary-butyl perbenzoate, tertiary-butyl peracetate, benzoyl peroxide, ditertiary-butyl peroxide, and tertiary amyl peroxy 2-ethylhexyl carbonate.

Optionally, a chain transfer agent which is soluble in the mixture such as alkyl mercaptans, for example, tertiary-dodecyl mercaptan; ketones such as methyl ethyl ketone, chlorohydrocarbons such as chloroform, or thiocarbonyl and nitroxide compounds can be used. A chain transfer agent provides control over the molecular weight to give products having required viscosity for various coating applications.

To prepare the homopolymer, the solvent may be first heated to reflux and the mixture of polymerizable monomer containing the free radical initiator may be added slowly to the refluxing solvent. The reaction mixture is then held at polymerizing temperatures so as to reduce the free monomer content, such as to below 1.0 percent and usually below 0.5 percent, based on the total weight of the polymerizable monomer.

In a preferred embodiment, the process for preparing the homopolymers of this disclosure comprises mixing in a reaction vessel, with heating and an inert atmosphere, a substituted or unsubstituted, unsaturated, conjugated aromatic monomer, a radical initiator, and a solvent, for a period of time sufficient to form a homopolymer; obtaining the homopolymer in a solvent as a concentrate; and removing the solvent under vacuum to obtain the neat homopolymer.

### Dispersants

The copolymers and homopolymers of this disclosure are effective as dispersants. In a preferred embodiment, the copolymers and homopolymers of this disclosure can effectively wet and disperse CNTs in NMP, as well as lithium iron phosphate (LFP) active materials in cathode slurries of NMP.

The copolymer and homopolymer dispersants can be used in a dispersion (e.g., CNT dispersion) to achieve lower viscosity of the dispersion than a control dispersion, and/or increase solid content of the dispersion, thereby making the dispersion formulation attractive for LiB manufacturers.

Additionally, the copolymer and homopolymer dispersants can be used in a cathode slurry formulation (e.g., LFP cathode slurry formulation) to achieve lower viscosity than a control cathode slurry formulation at high solid content, thereby making the dispersants attractive for LiB manufacturers' cathode slurry formulations.

### Dispersant Concentrates

The dispersant concentrates of this disclosure comprise at least one copolymer or homopolymer dispersant of this disclosure, and at least one solvent (e.g., dispersing medium).

The copolymer or homopolymer dispersant can be present in the dispersant concentrate in an amount from about 10 to about 80 wt %, or from about 20 to about 60 wt %, or from about 40 to about 60 wt %; and the solvent is present in an amount from about 20 to about 90 wt %, or from about 40 to about 80 wt %, or from about 40 to about 60 wt %, based on the total weight of the dispersant concentrate.

Illustrative solvents for the dispersant concentrate include, for example, an organic solvent including any one thereof or two or more hetero atoms selected from a nitrogen atom (N) and an oxygen atom (O) having an unshared electron pair.

Specifically, the solvent or dispersion medium may be an amide-based polar organic solvent such as dimethylformamide (DMF), diethylformamide, dimethylacetamide (DMAc) and N-methylpyrrolidone (NMP); an alcohol such as methanol, ethanol, 1-propanol, 2-propanol (isopropyl alcohol), 1-butanol (n-butanol), 2-methyl-1-propanol (isobutanol), 2-butanol (sec-butanol), 1-methyl-2-propanol (tert-butanol), pentanol, hexanol, heptanol and octanol; a glycol such as ethylene glycol, diethylene glycol, triethylene glycol, propylene glycol, 1,3-propanediol, 1,3-butanediol, 1,5-pentanediol, and hexylene glycol; a polyhydric alcohol such as glycerin, trimethylol propane, pentaerythritol, and sorbitol; a glycol ether such as ethylene glycol monomethyl ether, diethylene glycol monomethyl ether, triethylene glycol monomethyl ether, tetraethylene glycol monomethyl ether, ethylene glycol monoethyl ether, diethylene glycol monoethyl ether, triethylene glycol monoethyl ether, tetraethylene glycol monoethyl ether, ethylene glycol monobutyl ether, diethylene glycol monobutyl ether, triethylene glycol monobutyl ether, and tetraethylene glycol monobutyl ether; a ketone such acetone, methyl ethyl ketone, methyl propyl ketone, and cyclopentanone; an ester such as ethyl acetate, 7-butyl lactone, and ε-propiactone. Any one thereof or a mixture of two or more thereof may be used. When considering the miscibility with an electrode slurry, N-methylpyrrolidone (NMP) is particularly preferable among the above.

Preferred solvents for the dispersant concentrate include, for example, N-methyl-2-pyrrolidone (NMP), water, toluene, xylene, isopropanol, ethyl acetate, butyl butyrate, and combinations thereof.

Typical dispersant concentrates of this disclosure, with component concentrations, are shown in Table A below.

TABLE A

| | | Preferred | More preferred | |
|---|---|---|---|---|
| Component | Function | wt % | wt % | Range wt % |
| Dispersant | Dispersing | 20-60% | 40-60% | 10-80% |
| | agent | | | |
| NMP | Solvent | 40-80% | 40-60% | 20-90% |

The dispersant concentrates of the present disclosure including the above components may be prepared by mixing the dispersant(s) and solvent(s) or dispersion medium. The mixing may be performed by a typical mixing method, for example, by known means such as a stirrer, bead mill or high-pressure homogenizer, for example, by using a mixing device such as a homogenizer, a beads mill, a ball mill, a basket mill, an attrition mill, an all-purpose stirrer, a clear mixer, a spike mill, a TK mixer, or the like.

As for mixing and agitation for the manufacture of the dispersant concentrates, a mixer capable of stirring these components to such an extent that satisfactory dispersion conditions are met should be selected. Examples of the mixers which meets this condition include ball mill, sand mill, pigment disperser, grinding machine, extruder, rotor stator, pug mill, ultrasonic disperser, homogenizer, planetary mixer, Hobart mixer, and combinations thereof.

### Conductive Carbon Dispersions

The conductive carbon dispersions of this disclosure comprise at least one copolymer or homopolymer dispersant of this disclosure, or at least one dispersant concentrate of this disclosure, at least one conductive carbon, and at least one solvent.

Suitable conductive carbon includes, for example, carbon nanotubes, graphene, carbon black, graphite, and combinations thereof. The conductive carbon material is to improve the conductivity of an electrode.

Illustrative carbon nanotubes useful in this disclosure are described, for example, in WO 2022/040425 A1, the disclosure of which is incorporated herein by reference in its entirety.

In the carbon nanotube, a graphite sheet has a cylindrical shape of a nano-sized diameter and has a sp² bonding structure, and exhibits conductor or semiconductor properties depending on the angle and structure at which the graphite surface is rolled. The carbon nanotube may be classified as a single-walled carbon nanotube (SWCNT), a double-walled carbon nanotube (DWCNT), and a multi-walled carbon nanotube (MWCNT) depending on the number of walls forming the tubes. Such a carbon nanotube may be appropriately selected according to the use of the dispersion.

In addition, the carbon nanotube may have a secondary shape in which a plurality of carbon nanotubes are aggregated or arranged. For example, the carbon nanotube may be a bundle-type carbon nanotube in the form of a bundle or a rope in which or a plurality of carbon nanotubes are arranged or aligned in parallel in a predetermined direction, or may be an entangled-type carbon nanotube in the form of a sphere or a potato in which a plurality of carbon nanotubes are entangled without a certain directionality. In terms of dispersibility, it is more preferable that the carbon nanotube is a bundle-type carbon nanotube.

As the carbon black, commercially available furnace black, channel black, thermal black, acetylene black, ketjen black, hollow carbon black, or the like may be used. The type of the carbon nanotube is not particularly limited.

The carbon black may have been, as needed, surface-treated by a method known in the art. For example, the carbon black may have been surface-treated by acetylene gas, and thus, free of impurities. In addition, the carbon black may have a purity of 99.5% or greater.

The conductive carbon used in the present disclosure may have a BET specific surface area of 1000 m²/g or less, preferably 30 to 1000 m²/g. When the BET specific surface area of the conductive carbon is greater than 1000 m²/g, a dispersion may not be smoothly achieved.

Specifically, when the conductive carbon is a carbon nanotube, the BET specific surface area of the carbon nanotube may be 100 to 1000 m²/g, 150 to 800 m²/g, 150 to 500 m²/g, 150 to 300 m²/g, or 150 to 200 m²/g.

When the conductive carbon is carbon black, the BET specific surface area of the carbon black may be 30 to 1000 m²/g, preferably 30 to 400 m²/g, more preferably 30 to 380 m²/g, even more preferably 30 to 150 m²/g.

In an embodiment, the content of the conductive carbon in the conductive carbon dispersion may be 0.1 to 30 wt %, preferably 1 to 30 wt %. Specifically, when the conductive carbon is a carbon nanotube, the content of the conductive carbon in the conductive carbon dispersion may be 0.1 to 10 wt %, preferably 1 to 8 wt %, and when the conductive carbon is carbon black, the content of the conductive carbon in the conductive carbon dispersion may be 1 to 30 wt %, preferably 1 to 25 wt %. When the content of the conductive carbon is too low, there may be problems in that a loading amount is reduced during the manufacturing of an electrode, so that process cost increases, and binder migration occurs during the manufacturing of the electrode, so that adhesion force is reduced. Meanwhile, when the content of the conductive carbon is too high, there is a problem in that the viscosity of the conductive carbon dispersion increases too high to handle in the process.

In an embodiment, the carbon nanotubes useful in this disclosure have a BET specific surface area of 10 to 2000 m²/g, a Raman spectroscopy 2D/G peak ratio of 0.15 to 1.50, a length of 25 nm to 1 mm, an outer diameter at 0.1 to 100 nm, and an aspect ratio of 100:1 to 100,000,000:1.

The copolymer or homopolymer dispersant, or dispersant concentrate, components are described herein.

In the conductive carbon dispersions of this disclosure, the dispersant or dispersant in the dispersant concentrate is present in an amount from about 0.1 to about 6 wt %, or from about 0.1 to about 3 wt %, or from about 0.1 to about 1 wt %; the conductive carbon is present in an amount from about 0.5 to about 12 wt %, or from about 0.5 to about 4 wt %, or from about 0.5 to about 1 wt %; and the solvent is present in an amount from about 82 to about 99.5 wt %, or from about 82 to about 98 wt %, or from about 82 to about 95 wt %; based on the total weight of the conductive carbon dispersion.

The weight ratio of carbon nanotubes to dispersant in the conductive carbon dispersion of this disclosure may be 250:1 to 1:1, such as 100:1 to 2:1, such as 75:1 to 3:1, such as 50:1 to 5:1, such as 25:1 to 1:1, such as 25:1 to 2:1, such as 25:1 to 3:1, such as 25:1 to 4.1, such as 25:1 to 5:1, such as 25:1 to 7.5:1, such as 25:1 to 10:1, such as 25:1 to 15:1, such as 20:1 to 1:1, such as 20:1 to 2:1, such as 20:1 to 3:1, such as 20:1 to 4.1, such as 20:1 to 5:1, such as 20:1 to 7.5:1, such as 20:1 to 10:1, such as 20:1 to 15:1, such as 10:1 to 1:1, such as 10:1 to 2:1, such as 10:1 to 3:1, such as 10:1 to 4.1, such as 10:1 to 5:1, such as 10:1 to 7.5:1.

When more than one conductive carbon is present in the conductive carbon dispersion of this disclosure, the weight ratio of the conductive carbon other than carbon nanotubes to carbon nanotubes may be at least 1,000:1, such as at least 750:1, such as at least 400:1, such as at least 300:1, such as at least 200:1, such as at least 150:1, such as at least 125:1, such as at least 100:1, such as at least 75:1, such as at least 50:1, such as at least 25:1, such as at least 20:1, such as at least 15:1, such as at least 13:1, such as at least 10:1, such as at least 5:1. The weight ratio of the conductive carbon other than carbon nanotubes to carbon nanotubes may be no more than 5:1, such as no more than 10:1, such as no more than 15:1, such as no more than 20:1, such as no more than 25:1, such as no more than 50:1, such as no more than 75:1, such as no more than 100:1, such as no more than 125:1, such as no more than 150:1, such as no more than 200:1, such as no more than 300:1, such as no more than 400:1, such as no more than 75:1.

Illustrative solvents for the conductive carbon dispersions of this disclosure include, for example, an organic solvent including any one thereof or two or more hetero atoms selected from a nitrogen atom (N) and an oxygen atom (O) having an unshared electron pair.

Specifically, the solvent or dispersion medium may be an amide-based polar organic solvent such as dimethylformamide (DMF), diethylformamide, dimethylacetamide (DMAc) and N-methylpyrrolidone (NMP); an alcohol such as methanol, ethanol, 1-propanol, 2-propanol (isopropyl alcohol), 1-butanol (n-butanol), 2-methyl-1-propanol (isobutanol), 2-butanol (sec-butanol), 1-methyl-2-propanol (tert-butanol), pentanol, hexanol, heptanol and octanol; a glycol such as ethylene glycol, diethylene glycol, triethylene glycol, propylene glycol, 1,3-propanediol, 1,3-butanediol, 1,5-pentanediol, and hexylene glycol; a polyhydric alcohol such as glycerin, trimethylol propane, pentaerythritol, and sorbitol; a glycol ether such as ethylene glycol monomethyl ether, diethylene glycol monomethyl ether, triethylene glycol monomethyl ether, tetraethylene glycol monomethyl ether, ethylene glycol monoethyl ether, diethylene glycol monoethyl ether, triethylene glycol monoethyl ether, tetraethylene glycol monoethyl ether, ethylene glycol monobutyl ether, diethylene glycol monobutyl ether, triethylene glycol monobutyl ether, and tetraethylene glycol monobutyl ether; a ketone such acetone, methyl ethyl ketone, methyl propyl ketone, and cyclopentanone; an ester such as ethyl acetate, 7-butyl lactone, and ε-propiactone. Any one thereof or a mixture of two or more thereof may be used. When considering the miscibility with an electrode slurry, N-methylpyrrolidone (NMP) is particularly preferable among the above.

Preferred solvents for the conductive carbon dispersions of this disclosure include, for example, N-methyl-2-pyrrolidone, water, toluene, xylene, isopropanol, ethyl acetate, butyl butyrate, and combinations thereof.

Typical conductive carbon dispersions of this disclosure, with component concentrations, are shown in Table B below.

TABLE B

| | | Preferred | More | |
|---|---|---|---|---|
| Component | Function | wt % | preferred | Range wt % |
| Conductive | Conductive | 1% | 4% | 0.5-12% |
| carbon | agent | | | |
| Dispersant | Dispersing | 1% | 1% | 0.1-6% |
| | agent | | | |
| NMP | Solvent | 98% | 95% | 82-99.4% |

The conductive carbon dispersions of this disclosure including the above components may be prepared by mixing the dispersant(s) or dispersant concentrate(s), conductive carbon material(s), and solvent(s) or dispersion medium. The mixing may be performed by a typical mixing method, for example, by known means such as a stirrer, bead mill or high-pressure homogenizer, for example, by using a mixing device such as a homogenizer, a beads mill, a ball mill, a basket mill, an attrition mill, an all-purpose stirrer, a clear mixer, a spike mill, a TK mixer, or the like. The mixing order of each component is not particularly limited. That is, the conductive carbon dispersion of the present disclosure may be prepared by adding a conductive carbon material to a dispersion medium, and then adding a dispersant thereto, followed by mixing; or prepared by first adding a dispersant to a dispersion medium, and then mixing a conductive carbon material therewith; or prepared by adding both a dispersant and a conductive carbon material to a dispersion medium, followed by mixing.

As for mixing and agitation for the manufacture of the conductive carbon dispersion, a mixer capable of stirring these components to such an extent that satisfactory dispersion conditions are met should be selected. The degree of dispersion can be measured with a particle gauge and mixing and dispersion are preferably carried out to ensure that agglomerates of 100 microns or more are not present. Examples of the mixers which meets this condition include ball mill, sand mill, pigment disperser, grinding machine, extruder, rotor stator, pug mill, ultrasonic disperser, homogenizer, planetary mixer, Hobart mixer, and combinations thereof.

The solid content of the conductive carbon dispersions of this disclosure is determined according to the solid amount of the dispersant or dispersant concentrate, and conductive carbon material. In accordance with this disclosure, the conductive carbon dispersions have a high solid content, while surprisingly exhibiting low viscosity properties.

In an embodiment, the conductive carbon dispersions of this disclosure exhibit high solid content and low viscosity properties. For example, the conductive carbon dispersions of this disclosure have a viscosity (Pa·s) from about 1 to about 80 Pa·s, and a solids content (wt %) from about 0.5 to about 25 wt %, at a shear rate (l/s) from about 0.1 to about 100 l/s; or a viscosity (Pa·s) from about 5 to about 75 Pa·s, and a solids content (wt %) from about 0.5 to about 20 wt %, at a shear rate (l/s) from about 0.1 to about 100 l/s; or a viscosity (Pa·s) from about 5 to about 50 Pa·s, and a solids content (wt %) from about 0.5 to about 18 wt %, at a shear rate (l/s) from about 0.1 to about 100 l/s; or a viscosity (Pa·s) from about 5 to about 25 Pa·s, and a solids content (wt %) from about 0.5 to about 15 wt %, at a shear rate (l/s) from about 0.1 to about 100 l/s.

### Electrode Slurry Compositions

In accordance with this disclosure, the electrode slurry composition for producing a battery positive electrode comprise conductive carbon, or the conductive carbon dispersion of this disclosure, at least one electrode active material, at least one binder, and optionally at least one solvent.

The conductive carbon dispersions of this disclosure are described herein.

In the electrode slurry compositions of this disclosure, the conductive carbon, or conductive carbon in the dispersion is present in an amount from about 0.1 to about 10 wt %, 0.1 to about 8 wt %, 0.1 to about 6 wt %, or from about 0.1 to about 3 wt %, or from about 0.1 to about 1 wt %; based on the total weight of the electrode slurry composition.

The electrode active material may comprise a material for use as an active material for a positive electrode. The electrochemically electrode active material may comprise a material capable of incorporating lithium (including incorporation through lithium intercalation/deintercalation), a material capable of lithium conversion, or combinations thereof. Non-limiting examples of electrode active materials capable of incorporating lithium include LiCoO₂, LiNiO₂, LiFePO₄, LiMnₓFe₍₁₋ₓ₎PO₄, LiCoPO₄, LiMnO₂, LiM₂O₄, Li(NiMnCo)O₂, Li(NiCoAl)O₂, or their carbon-coated versions, and combinations thereof. Non-limiting examples of materials capable of lithium conversion include sulfur, LiO₂, FeF₂ and FeF₃, aluminum, tin, SnCo, Fe₃O₄, and combinations thereof.

Illustrative electrode active materials include, for example, lithium iron phosphate (LiFePO₄), lithium manganese iron phosphate (LiMnₓFe₍₁₋ₓ₎PO₄), lithium manganese iron phosphate (LiMnₓFe₍₁₋ₓ₎PO₄), lithium cobalt oxide (LiCoO₂), lithium manganese oxide (LiMn₂O₄), lithium manganese oxide (Li₂MnO₃), lithium nickel manganese cobalt oxide (LiNi_{0.33}Mn_{0.33}Co_{0.33}O₂), lithium nickel manganese cobalt oxide (LiNi_{0.6}Mn_{0.2}Co_{0.2}O₂), and lithium nickel manganese cobalt oxide (LiNi_{0.8}Mn_{0.1}Co_{0.1}O₂).

Other illustrative electrode active materials include, for example, a lithium oxide containing one or more metals selected from the group consisting of cobalt, manganese, nickel, and aluminum; a lithium oxide selected from the group consisting of a lithium-manganese-based oxide, LiMnO₂, and LiMn₂O; a lithium-cobalt-based oxide, and LiCoO₂; a lithium-nickel-based oxide and LiNiO₂; a lithium-nickel-manganese-based oxide, LiNi_{1-Y1}Mn_{Y1}O₂ wherein 0<Y1<1, LiNi_{Z1}Mn_{2-Z1}O4 wherein 0<Z1<2; a lithium-nickel-cobalt-based oxide, LiNi_{1-Y2}Co_{Y2}O₂ wherein 0<Y2<1; a lithium-manganese-cobalt-based oxide, LiCo_{1-Y3}Mn_{Y3}O₂ wherein 0<Y3<1, LiMn_{2-Z2}Co_{Z2}O₄ wherein 0<Z2<2; a lithium-nickel-cobalt-manganese-based oxide, Li(Ni_{P1}Co_{Q1}Mn_{R1})O₂ wherein 0<P1<1, 0<Q1<1, 0<R1<1, P1+Q1+R1=1, Li(Ni_{P2}Co_{Q2}Mn_{R2})O₄ wherein 0<P2<2, 0<Q2<2, 0<R2<2, P2+Q2+R2=2; and a lithium-nickel-cobalt-manganese-other metal (M) oxide, Li(Ni_{P3}Co_{Q3}Mn_{R3}M¹s)O₂ wherein M¹ is selected from the group consisting of Al, Cu, Fe, V, Cr, Ti, Zr, Zn, Ta, Nb, Mg, B, W and Mo, and P3, Q3, R3, and S are each an atomic fraction of independent elements, and 0<P3<1, 0<Q3<1, 0<R3<1, 0<S<1, P3+Q3+R3+S=1; and combinations thereof.

The electrode active material may be present in the electrode slurry composition of this disclosure in amounts of 45% to 90% by weight, such as 50% to 90% by weight, such as 55% to 90% by weight, such as 60% to 90% by weight, such as 65% to 90% by weight, such as 70% to 90% by weight, such as 75% to 90% by weight, such as 80% to 90% by weight, such as 85% to 90% by weight, such as 55 to 85% by weight, such as 65% to 85% by weight, such as 70% to 85% by weight, such as 75% to 85% by weight, such as 80% to 85% by weight, based on the total solids weight of the electrode slurry composition.

Illustrative binders include, for example, polyvinylidene fluoride (PVDF), a vinylidene fluoride-hexafluoropropylene copolymer (PVDF-co-HFP), polyvinyl alcohol, polyacrylonitrile, carboxymethyl cellulose (CMC), starch, hydroxypropyl cellulose, regenerated cellulose, polyvinylpyrrolidone, polytetrafluoroethylene, polyethylene, polypropylene, an ethylene-propylene-diene monomer (EPDM), a sulfonated-EPDM, styrene-butadiene rubber (SBR), fluorine rubber, or copolymers thereof, and combinations thereof.

The binder may be included in the electrode slurry compositions of this disclosure in an amount of about 5 wt % or less, or about 4 wt % or less, or about 3 wt % or less, or about 2 wt % or less, or about 1 wt % or less, based on the total solid content in the electrode slurry composition, and may preferably be included in an amount from about 1 to about 3 wt %. When the content of binder satisfies the above range, it is possible to implement excellent electrode adhesion force while minimizing the increase in electrode resistance.

In an embodiment, the electrode active material is lithium iron phosphate (LFP) and is present in an amount of about 100 parts by weight; the conductive carbon is present in an amount from about 0.2 to about 10 parts by weight, or from about 0.5 to about 2 parts by weight, or from about 0.5 to about 1.5 parts by weight; the dispersant is present in an amount from about 0.02 to about 0.5 parts by weight, or from about 0.05 to about 0.02 parts by weight, or from about 0.1 to about 0.2 parts by weight; the binder is present in an amount from about 0.5 to about 5 parts by weight, or from about 1.5 to about 2 parts by weight, or from about 0.5 to about 2 parts by weight; and the solvent is present in an amount from about 50 to about 75 parts by weight, or from about 55 to about 70 parts by weight, or from about 60 to about 65 parts by weight.

In an embodiment, the electrode active material is lithium nickel manganese cobalt oxide (NMC) and is present in an amount of about 100 parts by weight, or from about 97 to 99 parts by weight, or from about 97 to about 98.3 parts by weight; the conductive carbon is carbon nanotubes and is present in an amount from about 0.2 to about 10 parts by weight, or from about 0.5 to about 2 parts by weight, or from about 0.5 to about 1.5 parts by weight; the binder is present in an amount from about 0.5 to about 5 parts by weight, or from about 0.5 to about 1.5 parts by weight, or from about 0.5 to about 0.7 parts by weight; and the solvent is present in an amount from about 50 to about 75 parts by weight, or from about 55 to about 70 parts by weight, or from about 60 to about 65 parts by weight.

The electrode slurry composition of this disclosure may further include a solvent, if necessary, to control viscosity and the like. The solvent may be water, an organic solvent, or a mixture thereof. The organic solvent may be, for example, an amide-based polar organic solvent such as dimethylformamide (DMF), diethylformamide, dimethylacetamide (DMAc), and N-methylpyrrolidone (NMP); an alcohol such as methanol, ethanol, 1-propanol, 2-propanol (isopropyl alcohol), 1-butanol (n-butanol), 2-methyl-1-propanol (isobutanol), 2-butanol (sec-butanol), 1-methyl-2-propanol (tert-butanol), pentanol, hexanol, heptanol, and octanol; a glycol such as ethylene glycol, diethylene glycol, triethylene glycol, propylene glycol, 1,3-propanediol, 1,3-butanediol, 1,5-pentanediol, and hexylene glycol; a polyhydric alcohol such as glycerin, trimethylol propane, pentaerythritol, and sorbitol; a glycol ether such as ethylene glycol monomethyl ether, diethylene glycol monomethyl ether, triethylene glycol monomethyl ether, tetraethylene glycol monomethyl ether, ethylene glycol monoethyl ether, diethylene glycol monoethyl ether, triethylene glycol monoethyl ether, tetraethylene glycol monoethyl ether, ethylene glycol monobutyl ether, diethylene glycol monobutyl ether, triethylene glycol monobutyl ether, and tetraethylene glycol monobutyl ether; a ketone such acetone, methyl ethyl ketone, methyl propyl ketone, and cyclopentanone; and an ester such as ethyl acetate, 7-butyl lactone, and ε-propiactone. Any one thereof and a mixture of two or more thereof may be used, but the organic solvent is not limited thereto.

The solvent may be included in a content such that the solid content in the electrode slurry composition becomes 55 to 85 wt %, preferably 60 to 80 wt %. When the solid content of the electrode slurry composition is less than 55 wt %, an electrode loading amount may be reduced, thereby increasing process cost, binder migration may occur, thereby degrading electrode adhesion force, and coating defects may be generated. When the solid content of the electrode slurry composition is greater than 85 wt %, the viscosity of the electrode slurry composition becomes too high, so that processability may be deteriorated and coating defects may be generated.

Typical electrode slurry compositions of this disclosure, with component concentrations, are shown in Tables C (LFP electrode slurry composition) and D (NMC electrode slurry composition) below.

TABLE C

| | | | More | |
|---|---|---|---|---|
| | | Preferred | Preferred | Range |
| Component | Function | (part) | (part) | (part) |
| Lithium iron | Active | 100 | 100 | 100 |
| phosphate | materials | | | |
| (LFP) | | | | |
| Conductive | Conductive | 0.5-2.0 | 1.5 | 0.2-10 |
| carbon | agent | | | |
| Dispersant | Dispersing | 0.1-0.2 | 0.2 | 0.02-0.5 |
| | agent | | | |
| PVDF | Binder | 1.5-2.0 | 2.0 | 0.5-5.0 |
| Total above | Solid content | 102.1-104.2 | 103.7 | 100.72-115.5 |
| (non-volatile) | (SC) | | | |
| NMP | Solvent | Balanced to | Balanced to | Balanced to |
| | | 60-70% SC | 65% SC | 50-75% SC |

TABLE D

| | | | More | |
|---|---|---|---|---|
| | | Preferred | Preferred | Range |
| Component | Function | (part) | (part) | (part) |
| Lithium | Active | 97.0-99.0 | 98.3 | 100 |
| Nickel | materials | | | |
| Manganese | | | | |
| Cobalt Oxide | | | | |
| (NMC) | | | | |
| Carbon | Conductive | 0.5-2.0 | 1.0 | 0.2-10.0 |
| Nanotubes | agent | | | |
| (CNT) | | | | |
| PVDF | Binder | 0.5-1.5 | 0.7 | 0.5-5.0 |
| Total above | Solid content | 98.1-103.5 | 100.25 | 100.72-120.0 |
| (non- | (SC) | | | |
| volatile) | | | | |
| NMP | Solvent | Balanced to | Balanced to | Balanced to |
| | | situable | situable | situable |
| | | viscosity | viscosity | viscosity |

The electrode slurry compositions of this disclosure including the above components may be prepared by mixing or agitating the conductive carbon, conductive carbon dispersion of this disclosure, the electrode active material, the binder, and optionally the solvent. The mixing may be performed by a typical mixing method, for example, by known means such as a stirrer, bead mill or high-pressure homogenizer, for example, by using a mixing device such as a homogenizer, a beads mill, a ball mill, a basket mill, an attrition mill, an all-purpose stirrer, a clear mixer, a spike mill, a TK mixer, or the like. The mixing order of each component is not particularly limited. That is, the electrode slurry compositions of the present disclosure may be prepared by adding a conductive carbon dispersion of this disclosure to a dispersion medium, then adding an electrode active material thereto, and then adding a binder thereto, followed by mixing; or prepared by first adding an electrode active material to a dispersion medium, and then mixing binder and a conductive carbon dispersion of this disclosure therewith; or prepared by adding a conductive carbon dispersion of this disclosure thereto, an electrode active material, and a binder, all together to a dispersion medium, followed by mixing.

As for mixing and agitation for the manufacture of the electrode slurry composition, a mixer capable of stirring these components to such an extent that satisfactory dispersion conditions are met should be selected. The degree of dispersion can be measured with a particle gauge and mixing and dispersion are preferably carried out to ensure that agglomerates of 100 microns or more are not present. Examples of the mixers which meets this condition include ball mill, sand mill, pigment disperser, grinding machine, extruder, rotor stator, pug mill, ultrasonic disperser, homogenizer, planetary mixer, Hobart mixer, and combinations thereof.

The solid content of the positive electrode slurry composition of this disclosure is determined according to the solid amount of the conductive carbon dispersion, the electrode active material, and the binder. When the solid content of a positive electrode slurry composition is high, there are effects such as the increase in productivity, improvement in electrode drying efficiency and binder migration, improvement in adhesion force, and the like. In accordance with this disclosure, the electrode slurry compositions have a high solid content, while surprisingly exhibiting low viscosity properties.

In an embodiment, the electrode slurry compositions of this disclosure exhibit high solid content and low viscosity properties. For example, the electrode slurry compositions of this disclosure have a viscosity (Pa·s) from about 5 to about 30 Pa·s, and a solids content (wt %) from about 50 to about 80 wt %, at a shear rate (l/s) from about 0.1 to about 100 l/s; or a viscosity (Pa·s) from about 5 to about 25 Pa·s, and a solids content (wt %) from about 50 to about 75 wt %, at a shear rate (l/s) from about 0.1 to about 100 l/s; or a viscosity (Pa·s) from about 5 to about 20 Pa·s, and a solids content (wt %) from about 50 to about 70 wt %, at a shear rate (l/s) from about 0.1 to about 100 l/s; or a viscosity (Pa·s) from about 5 to about 15 Pa·s, and a solids content (wt %) from about 55 to about 70 wt %, at a shear rate (l/s) from about 0.1 to about 100 l/s.

### Positive Electrodes

The positive electrodes of this disclosure comprise an electrical current collector and a film formed on the electrical current collector, wherein the film is deposited from the electrode slurry composition of this disclosure, and the solvent subsequently removed.

The electrode according to the present disclosure may be manufactured by forming an electrode active material layer by applying an electrode slurry composition including the above components, followed by drying. Specifically, the electrode active material layer may be formed by a method in which an electrode slurry composition is applied on an electrode current collector and then dried, or by a method in which an electrode slurry is applied on a separate support, and then laminating a film obtained by being peeled off from the support on an electrode current collector. If necessary, after forming an electrode active material layer through the above method, a process of roll-pressing the same may be additionally performed. At this time, drying and roll-pressing may be performed under appropriate conditions in consideration of the physical properties of an electrode to be finally manufactured, and are not particularly limited.

The electrode active material layer may have a thickness of at least 1 micron, such as 1 to 500 microns (μm), such as 1 to 150 μm, such as 25 to 150 μm, such as 30 to 125 μm. The current collector may comprise a conductive material, and the conductive material may comprise a metal such as iron, copper, aluminum, nickel, and alloys thereof, as well as stainless steel. For example, the current collector may comprise aluminum or copper in the form of a mesh, sheet, or foil.

Although the shape and thickness of the current collector are not particularly limited, the current collector may have a thickness of about 0.001 to 0.5 μm, such as a mesh, sheet or foil having a thickness of about 0.001 to 0.5 μm.

In addition, the current collector may be pretreated with a pretreatment composition prior to depositing the slurry composition. As used herein, a pretreatment composition refers to a composition that upon contact with the current collector, reacts with and chemically alters the current collector surface and binds to it to form a protective layer. The pretreatment composition may be a pretreatment composition comprising a group IIB and/or IVB metal.

The method of applying the electrode slurry composition to the current collector is not particularly limited. The electrode slurry composition may be applied by doctor blade coating, dip coating, reverse roll coating, direct roll coating, gravure coating, extrusion coating, immersion or brushing. Although the application quantity of the electrode slurry composition is not particularly limited, the thickness of the coating formed after the organic medium is removed may be 25 to 150 microns (μm), such as 30 to 125 μm.

Drying the coating film after application, if applicable, can be done, for example, by heating at elevated temperature, such as at least 50° C., such as at least 60° C., such as 50-145° C., such as 60-120° C., such as 65-110° C. The time of heating will depend somewhat on the temperature. Generally, higher temperatures require less time for drying. Typically, drying times are for at least 5 minutes, such as 5 to 60 minutes.

### Electrical Storage Devices

Electrical storage devices of this disclosure comprise the positive electrode of this disclosure, a negative electrode, a separator, and an electrolyte. Preferably, the electrical storage device is a cell, a battery, a battery pack, a secondary battery, or a capacitor.

In an embodiment, a secondary battery includes the positive electrode of the present disclosure. Specifically, the secondary battery according to the present disclosure may include a positive electrode of this disclosure, a negative electrode, a separator interposed between the positive electrode and the negative electrode, and an electrolyte.

The positive electrode according to the present disclosure has been described herein.

The separator is to separate the negative electrode and the positive electrode and to provide a movement path for lithium ions. Any separator may be used without particular limitation as long as it is a separator typically used in a lithium secondary battery. Specifically, as the separator, a porous polymer film, for example, a porous polymer film manufactured using a polyolefin-based polymer such as an ethylene homopolymer, a propylene homopolymer, an ethylene/butene copolymer, an ethylene/hexene copolymer, and an ethylene/methacrylate copolymer, or a laminated structure having two or more layers thereof may be used. Also, a typical porous non-woven fabric, for example, a non-woven fabric formed of glass fiber having a high melting point, polyethylene terephthalate fiber, or the like may be used. Also, a coated separator including a ceramic component or a polymer material may be used to secure heat resistance or mechanical strength, and may be selectively used in a single-layered or a multi-layered structure.

The electrolyte may be an organic liquid electrolyte, an inorganic liquid electrolyte, a solid polymer electrolyte, a gel-type polymer electrolyte, a solid inorganic electrolyte, a molten-type inorganic electrolyte, and the like, which may be used in the preparation of a lithium secondary battery, but is not limited thereto.

Specifically, the electrolyte may include a non-aqueous organic solvent and a lithium salt.

As the non-aqueous organic solvent, for example, an aprotic organic solvent, such as N-methyl-2-pyrrolidone, propylene carbonate, ethylene carbonate, butylene carbonate, dimethyl carbonate, diethyl carbonate, 7-butyrolactone, 1,2-dimethoxy ethane, tetrahydroxyfuran, 2-methyl tetrahydrofuran, dimethyl sulfoxide, 1,3-dioxolane, formamide, diemthylformamide, dioxolane, acetonitrile, nitromethane, methyl formate, methyl acetate, phosphate triester, trimethoxy methane, a dioxolane derivative, sulfolane, methyl sulfolane, 1,3-dimethyl-2-imidazolidinone, a propylene carbonate derivative, a tetrahydrofuran derivative, ether, methyl propionate, and ethyl propionate may be used.

In particular, among the carbonate-based organic solvents, a cyclic carbonate such as ethylene carbonate and propylene carbonate may preferably be used since it is an organic solvent of high viscosity and has high dielectric constant to dissociate a lithium salt well. Such a cyclic carbonate may be more preferably used since when it is mixed with a linear carbonate of low viscosity and low dielectric constant such as dimethyl carbonate and diethyl carbonate in an appropriate ratio, an electrolyte having a high electric conductivity is prepared.

As the metal salt, a lithium salt may be used. The lithium salt is a material which is easily dissolved in the non-aqueous electrolyte solution. For example, as an anion of the lithium salt, one or more selected from the group consisting of F⁻, Cl⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃—, (CF₃SO₂)₂N⁻, (FSO₂)₂N⁻, CF₃CF₂(CF₃)₂CO⁻, (CF₃SO₂)₂CH⁻, (SFs)₃C⁻, (CF₃SO₂)₃C⁻, CF₃(CF₂)₇SO₃⁻, CF₃CO₂⁻, CH₃CO₂⁻, SCN⁻, and (CF₃CF₂SO₂)₂N⁻ may be used.

In the electrolyte, in order to improve the lifespan properties of a battery, to suppress the decrease in battery capacity, and to improve the discharge capacity of the battery, one or more additives, for example, a halo-alkylene carbonate-based compound such as difluoroethylene carbonate, pyridine, triethylphosphite, triethanolamine, cyclic ether, ethylenediamine, n-glyme, hexaphosphoric triamide, a nitrobenzene derivative, sulfur, a quinone imine dye, N-substituted oxazolidinone, N,N-substituted imidazolidine, ethylene glycol dialkyl ether, an ammonium salt, pyrrole, 2-methoxy ethanol, or aluminum trichloride, and the like may be further included other than the above electrolyte components.

As used herein, the term “polymer” refers broadly to oligomers and homopolymers, copolymers, and polymers. The term “resin” is used interchangeably with “polymer”.

As used herein, the term “solids” refers to the non-volatile components of the conductive carbon dispersion or electrode slurry composition of the present disclosure and specifically excludes the organic medium.

As used herein, molecular weights were determined by gel permeation chromatography (GPC) using a polystyrene standard. The term “number average molecular weight (Mn)”, as used herein, refers to the absolute number average molecular weight (Mn) as measured by GPC. The term “weight average molecular weight (Mw)”, as used herein, refers to a conversion value for a standard polystyrene measured by GPC.

Additionally or alternatively, the present disclosure may include one or more of the following embodiments:

Embodiment 1. A copolymer comprising:
structural units comprising the residue of a substituted or unsubstituted, unsaturated organic nitrile monomer; and
structural units comprising the residue of a substituted or unsubstituted, unsaturated, conjugated aromatic monomer selected from the group consisting of a conjugated aromatic ester monomer, a conjugated aromatic ether monomer, a conjugated aromatic amide monomer, a conjugated aromatic alkylene monomer, and combinations thereof,
wherein the structural units comprising the residue of a substituted or unsubstituted, unsaturated, conjugated aromatic monomer are present in an amount from about 45 to about 99 wt %, and the structural units comprising the residue of the substituted or unsubstituted, unsaturated organic nitrile monomer are present in an amount from about 1 to about 55 wt %, based on the total weight of the copolymer.

Embodiment 2. The copolymer of embodiment 1 which is in the form of a block copolymer, a random copolymer, or a gradient copolymer.

Embodiment 3. The copolymer of embodiment 1 wherein the substituted or unsubstituted, unsaturated organic nitrile monomer is substituted or unsubstituted acrylonitrile monomer.

Embodiment 4. The copolymer of embodiment 1 wherein the substituted or unsubstituted, unsaturated organic nitrile monomer is represented by the formula:

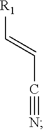

or by formula:

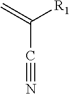

wherein R₁ is hydrogen or an alkyl group having from 1 to 10 carbon atoms.

Embodiment 5. The copolymer of embodiment 4 wherein R₁ is hydrogen.

Embodiment 6. The copolymer of embodiment 1 wherein the substituted or unsubstituted, unsaturated, conjugated aromatic monomer is represented by the formula:

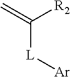

wherein R₂ is hydrogen or an alkyl group having from 1 to 10 carbon atoms; L is a linkage group selected from the group consisting of an ester linkage group, an ether linkage group, an amide linkage group, an alkylene linkage group; and any combination thereof; and Ar is a substituted or unsubstituted conjugated aromatic group having at least 1 aromatic ring.

Embodiment 7. The copolymer of embodiment 6 wherein R₂ is hydrogen, or an alkyl group having from 1 to 8 carbon atoms, or an alkyl group having from 1 to 6 carbon atoms, or an alkyl group having from 1 to 4 carbon atoms, or an alkyl group having 1 or 2 carbon atoms, or a methyl group.

Embodiment 8. The copolymer of embodiment 6 wherein the ester linkage group is represented by the formula:

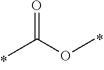

Embodiment 9. The copolymer of embodiment 6 wherein the ether linkage group is represented by the formula selected from the group consisting of:

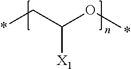

wherein X₁ is hydrogen, or an alkyl group having from 1 to 10 carbon atoms, or an alkyl group having from 1 to 8 carbon atoms, or an alkyl group having from 1 to 6 carbon atoms, or an alkyl group having from 1 to 4 carbon atoms, or an alkyl group having 1 or 2 carbon atoms, or a methyl group; and n is a value from 0 to 24, or a value from 0 to 20, or a value from 0 to 15, or a value from 0 to 10, or a value from 0 to 5;

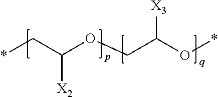

wherein X₂ and X₃ are independently hydrogen or an alkyl group having from 1 to 10 carbon atoms, or an alkyl group having from 1 to 8 carbon atoms, or an alkyl group having from 1 to 6 carbon atoms, or an alkyl group having from 1 to 4 carbon atoms, or an alkyl group having 1 or 2 carbon atoms, or a methyl group; and p and q are independently a value from 0 to 24, or a value from 0 to 20, or a value from 0 to 15, or a value from 0 to 10, or a value from 0 to 5; and any combination thereof,

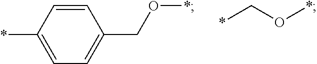

and any combination thereof.

Embodiment 10. The copolymer of embodiment 9 wherein n, p, and q are independently a value from 0 to 5; and X₁, X₂, and X₃ are independently hydrogen or methyl.

Embodiment 11. The copolymer of embodiment 6 wherein the amide linkage group is represented by the formula selected from the group consisting of:

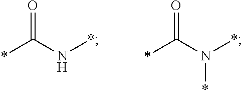

and
any combination thereof.

Embodiment 12. The copolymer of embodiment 6 wherein the alkylene linkage group is represented by the formula:

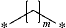

wherein m is a value from 1 to 10, or a value from 1 to 8, or a value from 1 to 6, or a value from 1 to 4, or a value from 1 to 2.

Embodiment 13. The copolymer of embodiment 12 wherein m is a value of 2.

Embodiment 14. The copolymer of embodiment 6 wherein Ar is represented by the formula selected from the group consisting of:

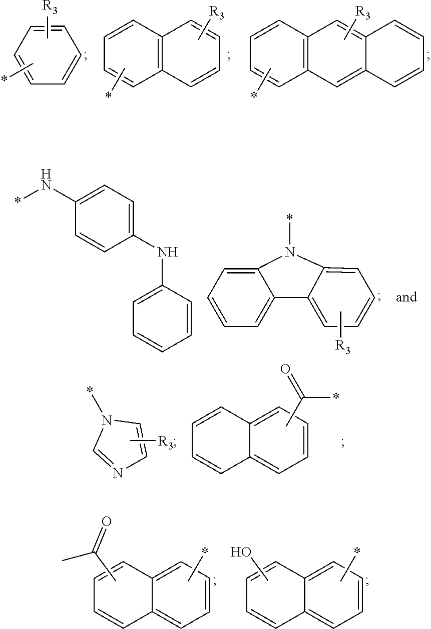

wherein R₃ is hydrogen or an alkyl group having from 1 to 10 carbon atoms, or an alkyl group having from 1 to 8 carbon atoms, or an alkyl group having from 1 to 6 carbon atoms, or an alkyl group having from 1 to 4 carbon atoms, or an alkyl group having 1 or 2 carbon atoms, or a methyl group.

Embodiment 15. The copolymer of embodiment 6 wherein Ar has at least 2 aromatic rings, or at least 3 aromatic rings, or at least 1 aromatic ring containing nitrogen.

Embodiment 16. The copolymer of embodiment 14 wherein R₃ is hydrogen.

Embodiment 17. The copolymer of embodiment 1 which is represented by the formula:

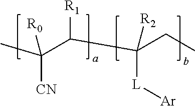

wherein R₀, R₁ and R₂ are independently hydrogen or an alkyl group having from 1 to 10 carbon atoms; L is a linkage group selected from the group consisting of an ester linkage group, an ether linkage group, an amide linkage group, an alkylene linkage group, and any combination thereof; Ar is a substituted or unsubstituted conjugated aromatic group having at least 1 aromatic ring; a is a value from about 10 to about 200; and b is a value from about 10 to about 200.

Embodiment 18. The copolymer of embodiment 1 wherein the substituted or unsubstituted, unsaturated organic nitrile monomer is acrylonitrile monomer represented by the formula:

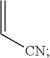

and
wherein the substituted or unsubstituted, unsaturated, conjugated aromatic monomer is 2-napthyl acrylate represented by the formula:

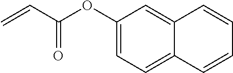

or 1-napthyl acrylate represented by the formula:

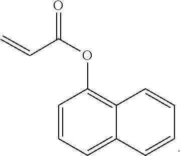

Embodiment 19. The copolymer of embodiment 1 which is poly(acrylonitrile 2-napthyl acrylate) (PANA) represented by the formula:

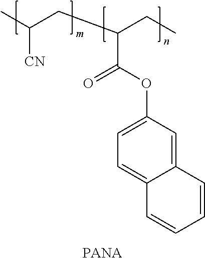

or a poly(acrylonitrile 1-napthyl acrylate) represented by the formula:

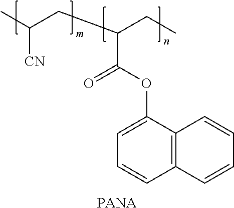

wherein m has a value from 10 to about 200, and n has a value from about 10 to about 200.

Embodiment 20. The copolymer of embodiment 1 wherein the structural units comprising the residue of the substituted or unsubstituted, unsaturated organic nitrile monomer are present in an amount from about 0.5 wt % to about 55 wt %, 1 wt % to about 50 wt %, or from about 1 wt % to about 45 wt %, or from about 1 wt % to about 40 wt %, or from about 1 wt % to about 35 wt %, or from about 1 wt % to about 30 wt %, or from about 1 wt % to about 25 wt %, or from about 1 wt % to about 20 wt %, or from about 1 wt % to about 15 wt %, or from about 1 wt % to about 10 wt %, or from about 1 wt % to about 5 wt %, based on the total weight of the copolymer.

Embodiment 21. The copolymer of embodiment 1 wherein the structural units comprising the residue of the substituted or unsubstituted, unsaturated, conjugated aromatic monomer are present in an amount from about 45 wt % to about 99.5 wt %, or from 50 wt % to about 99 wt %, or from about 55 wt % to about 99 wt %, or from about 60 wt % to about 99 wt %, or from about 65 wt % to about 99 wt %, or from about 70 wt % to about 99 wt %, or from about 75 wt % to about 99 wt %, or from about 80 wt % to about 99 wt %, or from about 85 wt % to about 99 wt %, or from about 90 wt % to about 99 wt %, based on the total weight of the copolymer.

Embodiment 22. The copolymer of embodiment 1 wherein the weight ratio of the structural units comprising the residue of the substituted or unsubstituted, unsaturated organic nitrile monomer to the structural units comprising the residue of the substituted or unsubstituted, unsaturated, conjugated aromatic monomer in the copolymer is from about 1:99 to about 55:45, or from about 1:99 to about 50:50, or from about 1:99 to about 45:55, or from about 1:99 to about 40:60, or from about 1:99 to about 35:65, or from about 1:99 to about 30:70, or from about 1:99 to about 25:75, or from about 1:99 to about 20:80, or from about 1:99 to about 15:85, or from about 1:99 to about 10:90, or from about 1:99 to about 5:95.

Embodiment 23. The copolymer of embodiment 1 which has a glass transition temperature (Tg) of 100° C. or less.

Embodiment 24. The copolymer of embodiment 1, which has a glass transition temperature (Tg) of 150° C. or less, or +50 to +150° C., or +60 to +140° C., or +70 to +130° C., +80 to +120° C., or +90 to +110° C., or −50 to +70° C., or −50 to +60° C., or −50 to +50° C., or −50 to +40° C., or −50 to +25° C., or −50 to +20° C., or −50 to +15° C., or −50 to +10° C., or −50 to +5° C., or −50 to 0° C., or −40 to +50° C., or −40 to +40° C., or −40 to +25° C., or −40 to +20° C., or −40 to +15° C., or −40 to +10° C., or −40 to +5° C., or −40 to 0° C., or −30 to +50° C., or −30 to +40° C., or −30 to +25° C., or −30 to +20° C., or −30 to +15° C., or −30 to +10° C., or −30 to +5° C., or −30 to 0° C., or −20 to +50° C., or −20 to +40° C., or −20 to +25° C., or −20 to +20° C., or −20 to +15° C., or −20 to +10° C., or −20 to +5° C., or −20 to 0° C., or −15 to +50° C., or −15 to +40° C., or −15 to +25° C., or −15 to +20° C., or −15 to +15° C., or −15 to +10° C., or −15 to +5° C., or −15 to 0° C., or −10 to +50° C., or −10 to +40° C., or −10 to +25° C., or −10 to +20° C., or −10 to +15° C., or −10 to +10° C., or −10 to +5° C., or −10 to 0° C., or −5 to +50° C., or −5 to +40° C., or −5 to +25° C., or −5 to +20° C., or −5 to +15° C., or −5 to +10° C., or −5 to +5° C., or −5 to 0° C., or −0 to +50° C., or −0 to +40° C., or −0 to +25° C., or −0 to +20° C., or −0 to +15° C.

Embodiment 25. The copolymer of embodiment 1 which has a weight average molecular weight of at least 2,500 g/mol, or at least 5,000 g/mol, or at least 7,500 g/mol, or least 10,000 g/mol.

Embodiment 26. The copolymer of embodiment 1 which has a weight average molecular weight of no more than 400,000 g/mol, or no more than 200,000 g/mol, or no more than 100,000, or no more than 75,000 g/mol, or no more than 50,000 g/mol, or no more than 25,000 g/mol, or no more than 20,000 g/mol, or no more than 15,000 g/mol, or no more than 10,000 g/mol, or no more than 7,500 g/mol.

Embodiment 27. The copolymer of embodiment 1 which has a weight average molecular weight of 2,500 to 400,000 g/mol, or 2,500 to 300000 g/mol, or 2,500 to 200,000 g/mol, or 2,500 to 100,000 g/mol, or 2,500 to 75,000 g/mol, or 2,500 to 50,000 g/mol, or 2,500 to 25,500 g/mol, or 2,500 to 10,000 g/mol, or 2.500 to 7,500 g/mol, or 5,000 to 400,000 g/mol, or 5,000 to 300,000 g/mol, or 5,000 to 200,000 g/mol, or 5,000 to 100,000 g/mol, or 5,000 to 75,000 g/mol, or 5,000 to 50,000 g/mol, or 5,000 to 25,000 g/mol, or 5,000 to 12,500 g/mol, or 5,000 to 10,000 g/mol, or 5,000 to 7.500 g/mol, or 7,500 to 400,000 g/mol, or 7,500 to 300,000 g/mol, or 7,500 to 200,000 g/mol, or 7,500 to 100,000 g/mol, or 7,500 to 75,000 g/mol, or 7,500 to 50,000 g/mol, or 7,500 to 25,000 g/mol, or 7,500 to 15,000 g/mol, or 7,500 to 12,500 g/mol, or 7,500 to 10,000 g/mol, or 10,000 to 400,000 g/mol, or 10,000 to 300,000 g/mol, or 10,000 to 200,000 g/mol, or 10,000 to 100,000 g/mol, or 10,000 to 75,000 g/mol, or 10,000 to 50,000 g/mol, or 10,000 to 25,000 g/mol, or 10,000 to 12,500 g/mol.

Embodiment 28. The copolymer of embodiment 1 which has a number average molecular weight of at least 5,000 g/mol, or at least 10,000 g/mol, or at least 15,000 g/mol, or at least 20,000 g/mol.

Embodiment 29. The copolymer of embodiment 1 which has a number average molecular weight of no more than 200,000 g/mol, or no more than 150,000 g/mol, or no more than 100,000 g/mol, or no more than 50,000 g/mol, or no more than 40,000 g/mol, or no more than 30,000 g/mol, or no more than 20,000 g/mol, or no more than 15,000 g/mol.

Embodiment 30. The copolymer of embodiment 1 which has a number average molecular weight of 5,000 to 200,000 g/mol, or 5,000 to 150,000 g/mol, or 5,000 to 100,000 g/mol, or 5,000 to 50,000 g/mol, or 5,000 to 40,000 g/mol, or 5,000 to 30,000 g/mol, or 5,000 to 25,000 g/mol, or 5,000 to 20,000 g/mol, or 5,000 to 15,000 g/mol, or 10,000 to 200,000 g/mol, or 10,000 to 150,000 g/mol, or 10,000 to 100,000 g/mol, or 10,000 to 50,000 g/mol, or 10,000 to 40,000 g/mol, or 10,000 to 30,000 g/mol, or 10,000 to 25,000 g/mol, or 10,000 to 20,000 g/mol, or 10,000 to 15,000 g/mol, or 15,000 to 200,000 g/mol, or 15,000 to 150,000 g/mol, or 15,000 to 100,000 g/mol, or 15,000 to 50,000 g/mol, or 15,000 to 40,000 g/mol, or 15,000 to 30,000 g/mol, or 15,000 to 25,000 g/mol, or 15,000 to 20,000 g/mol, or 20,000 to 200,000 g/mol, or 20,000 to 150,000 g/mol, or 20,000 to 100,000 g/mol, or 20,000 to 50,000 g/mol, or 20,000 to 40,000 g/mol, or 20,000 to 30,000 g/mol, or 20,000 to 25,000 g/mol.

Embodiment 31. A process for preparing a neat copolymer, said process comprising:
mixing in a reaction vessel, with heating and an inert atmosphere, a substituted or unsubstituted, unsaturated organic nitrile monomer, a substituted or unsubstituted, unsaturated, conjugated aromatic monomer, a radical initiator, and a solvent, for a period of time sufficient to form a copolymer;
obtaining the copolymer in a solvent as a concentrate; and
removing the solvent under vacuum to obtain the neat copolymer;
wherein copolymer comprises:
structural units comprising the residue of a substituted or unsubstituted, unsaturated organic nitrile monomer; and
structural units comprising the residue of a substituted or unsubstituted, unsaturated, conjugated aromatic monomer selected from the group consisting of a conjugated aromatic ester monomer, a conjugated aromatic ether monomer, a conjugated aromatic amide monomer, and a conjugated aromatic alkylene monomer, and combinations thereof;
wherein the structural units comprising the residue of the substituted or unsubstituted, unsaturated organic nitrile monomer are present in an amount from about 1 wt % to about 55 wt %, and the structural units comprising the residue of the substituted or unsubstituted, unsaturated, conjugated aromatic monomer are present in an amount from about 45 wt % to about 99 wt %, based on the total weight of the copolymer.

Embodiment 32. A dispersant comprising the copolymer of embodiments 1-30.

Embodiment 33. A homopolymer having structural units represented by the formula:

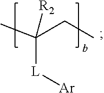

or by the formula

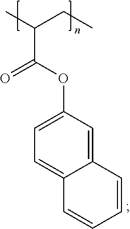

or by the formula:

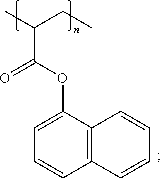

wherein R₂ is hydrogen or an alkyl group having from 1 to 10 carbon atoms; L is a linkage group selected from the group consisting of an ester linkage group, an ether linkage group, an amide linkage group, an alkylene linkage group, and any combination thereof; Ar is a substituted or unsubstituted conjugated aromatic group having at least 1 aromatic ring; and b and n are independently a value from about 10 to about 400; and wherein the ether linkage group is other than the ether linkage group represented by the formula:

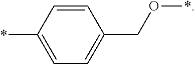

Embodiment 34. The homopolymer of embodiment 33 wherein R₂ is hydrogen, or an alkyl group having from 1 to 8 carbon atoms, or an alkyl group having from 1 to 6 carbon atoms, or an alkyl group having from 1 to 4 carbon atoms, or an alkyl group having 1 or 2 carbon atoms, or a methyl group.

Embodiment 35. The homopolymer of embodiment 33 wherein the ester linkage group is represented by the formula:

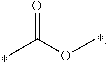

Embodiment 36. The homopolymer of embodiment 33 wherein the ether linkage group is represented by the formula selected from the group consisting of:

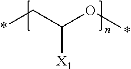

wherein X₁ is hydrogen, or an alkyl group having from 1 to 10 carbon atoms, or an alkyl group having from 1 to 8 carbon atoms, or an alkyl group having from 1 to 6 carbon atoms, or an alkyl group having from 1 to 4 carbon atoms, or an alkyl group having 1 or 2 carbon atoms, or a methyl group; and n is a value from 0 to 24, or a value from 0 to 20, or a value from 0 to 15, or a value from 0 to 10, or a value from 0 to 5;

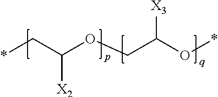

wherein X₂ and X₃ are independently hydrogen or an alkyl group having from 1 to 10 carbon atoms, or an alkyl group having from 1 to 8 carbon atoms, or an alkyl group having from 1 to 6 carbon atoms, or an alkyl group having from 1 to 4 carbon atoms, or an alkyl group having 1 or 2 carbon atoms, or a methyl group; and p and q are independently a value from 0 to 24, or a value from 0 to 20, or a value from 0 to 15, or a value from 0 to 10, or a value from 0 to 5; and any combination thereof,
   and any combinations thereof.

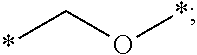

Embodiment 37. The homopolymer of embodiment 36 wherein n, p, and q are independently a value from 0 to 5; and X₁, X₂, and X₃ are independently hydrogen or methyl.

Embodiment 38. The homopolymer of embodiment 33 wherein the amide linkage group is represented by the formula selected from the group consisting of:

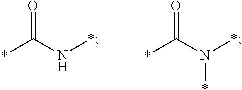

and
any combination thereof.

Embodiment 39. The homopolymer of embodiment 33 wherein the alkylene linkage group is represented by the formula:

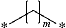

wherein m is a value from 1 to 10, or a value from 1 to 8, or a value from 1 to 6, or a value from 1 to 4, or a value from 1 to 2.

Embodiment 40. The homopolymer of embodiment 39 wherein m is a value of 2.

Embodiment 41. The homopolymer of embodiment 33 wherein Ar is represented by the formula selected from the group consisting of:

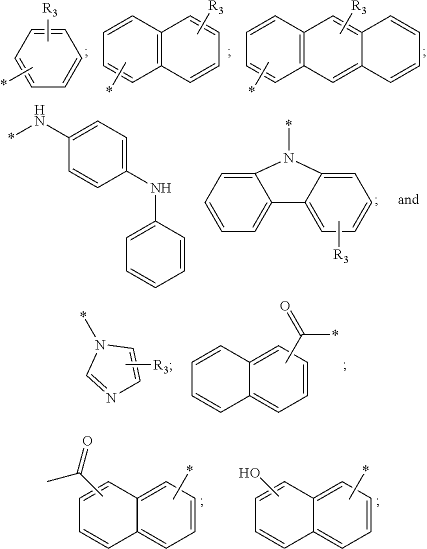

wherein R₃ is hydrogen or an alkyl group having from 1 to 10 carbon atoms, or an alkyl group having from 1 to 8 carbon atoms, or an alkyl group having from 1 to 6 carbon atoms, or an alkyl group having from 1 to 4 carbon atoms, or an alkyl group having 1 or 2 carbon atoms, or a methyl group.

Embodiment 42. The homopolymer of embodiment 33 wherein Ar has at least 2 aromatic rings, or at least 3 aromatic rings, or at least 1 aromatic ring containing nitrogen.

Embodiment 43. The homopolymer of embodiment 41 wherein R₃ is hydrogen.

Embodiment 44. The homopolymer of embodiment 33 which has a glass transition temperature (Tg) of 100° C. or less.

Embodiment 45. The homopolymer of embodiment 33, which has a glass transition temperature (Tg) of 150° C. or less, or +50 to +150° C., or +60 to +140° C., or +70 to +130° C., +80 to +120° C., or +90 to +110° C., or −50 to +70° C., or −50 to +60° C., or −50 to +50° C., or −50 to +40° C., or −50 to +25° C., or −50 to +20° C., or −50 to +15° C., or −50 to +10° C., or −50 to +5° C., or −50 to 0° C., or −40 to +50° C., or −40 to +40° C., or −40 to +25° C., or −40 to +20° C., or −40 to +15° C., or −40 to +10° C., or −40 to +5° C., or −40 to 0° C., or −30 to +50° C., or −30 to +40° C., or −30 to +25° C., or −30 to +20° C., or −30 to +15° C., or −30 to +10° C., or −30 to +5° C., or −30 to 0° C., or −20 to +50° C., or −20 to +40° C., or −20 to +25° C., or −20 to +20° C., or −20 to +15° C., or −20 to +10° C., or −20 to +5° C., or −20 to 0° C., or −15 to +50° C., or −15 to +40° C., or −15 to +25° C., or −15 to +20° C., or −15 to +15° C., or −15 to +10° C., or −15 to +5° C., or −15 to 0° C., or −10 to +50° C., or −10 to +40° C., or −10 to +25° C., or −10 to +20° C., or −10 to +15° C., or −10 to +10° C., or −10 to +5° C., or −10 to 0° C., or −5 to +50° C., or −5 to +40° C., or −5 to +25° C., or −5 to +20° C., or −5 to +15° C., or −5 to +10° C., or −5 to +5° C., or −5 to 0° C., or −0 to +50° C., or −0 to +40° C., or −0 to +25° C., or −0 to +20° C., or −0 to +15° C.

Embodiment 46. The homopolymer of embodiment 33 which has a weight average molecular weight of at least 2,500 g/mol, or at least 5,000 g/mol, or at least 7,500 g/mol, or least 10,000 g/mol.

Embodiment 47. The homopolymer of embodiment 33 which has a weight average molecular weight of no more than 400,000 g/mol, or no more than 200,000 g/mol, or no more than 100,000, or no more than 75,000 g/mol, or no more than 50,000 g/mol, or no more than 25,000 g/mol, or no more than 20,000 g/mol, or no more than 15,000 g/mol, or no more than 10,000 g/mol, or no more than 7,500 g/mol.

Embodiment 48. The homopolymer of embodiment 33 which has a weight average molecular weight of 2,500 to 400,000 g/mol, or 2,500 to 300000 g/mol, or 2,500 to 200,000 g/mol, or 2,500 to 100,000 g/mol, or 2,500 to 75,000 g/mol, or 2,500 to 50,000 g/mol, or 2,500 to 25,500 g/mol, or 2,500 to 10,000 g/mol, or 2.500 to 7,500 g/mol, or 5,000 to 400,000 g/mol, or 5,000 to 300,000 g/mol, or 5,000 to 200,000 g/mol, or 5,000 to 100,000 g/mol, or 5,000 to 75,000 g/mol, or 5,000 to 50,000 g/mol, or 5,000 to 25,000 g/mol, or 5,000 to 12,500 g/mol, or 5,000 to 10,000 g/mol, or 5,000 to 7.500 g/mol, or 7,500 to 400,000 g/mol, or 7,500 to 300,000 g/mol, or 7,500 to 200,000 g/mol, or 7,500 to 100,000 g/mol, or 7,500 to 75,000 g/mol, or 7,500 to 50,000 g/mol, or 7,500 to 25,000 g/mol, or 7,500 to 15,000 g/mol, or 7,500 to 12,500 g/mol, or 7,500 to 10,000 g/mol, or 10,000 to 400,000 g/mol, or 10,000 to 300,000 g/mol, or 10,000 to 200,000 g/mol, or 10,000 to 100,000 g/mol, or 10,000 to 75,000 g/mol, or 10,000 to 50,000 g/mol, or 10,000 to 25,000 g/mol, or 10,000 to 12,500 g/mol.

Embodiment 49. The homopolymer of embodiment 33 which has a number average molecular weight of at least 5,000 g/mol, or at least 10,000 g/mol, or at least 15,000 g/mol, or at least 20,000 g/mol.

Embodiment 50. The homopolymer of embodiment 33 which has a number average molecular weight of no more than 200,000 g/mol, or no more than 150,000 g/mol, or no more than 100,000 g/mol, or no more than 50,000 g/mol, or no more than 40,000 g/mol, or no more than 30,000 g/mol, or no more than 20,000 g/mol, or no more than 15,000 g/mol.

Embodiment 51. The homopolymer of embodiment 33 which has a number average molecular weight of 5,000 to 200,000 g/mol, or 5,000 to 150,000 g/mol, or 5,000 to 100,000 g/mol, or 5,000 to 50,000 g/mol, or 5,000 to 40,000 g/mol, or 5,000 to 30,000 g/mol, or 5,000 to 25,000 g/mol, or 5,000 to 20,000 g/mol, or 5,000 to 15,000 g/mol, or 10,000 to 200,000 g/mol, or 10,000 to 150,000 g/mol, or 10,000 to 100,000 g/mol, or 10,000 to 50,000 g/mol, or 10,000 to 40,000 g/mol, or 10,000 to 30,000 g/mol, or 10,000 to 25,000 g/mol, or 10,000 to 20,000 g/mol, or 10,000 to 15,000 g/mol, or 15,000 to 200,000 g/mol, or 15,000 to 150,000 g/mol, or 15,000 to 100,000 g/mol, or 15,000 to 50,000 g/mol, or 15,000 to 40,000 g/mol, or 15,000 to 30,000 g/mol, or 15,000 to 25,000 g/mol, or 15,000 to 20,000 g/mol, or 20,000 to 200,000 g/mol, or 20,000 to 150,000 g/mol, or 20,000 to 100,000 g/mol, or 20,000 to 50,000 g/mol, or 20,000 to 40,000 g/mol, or 20,000 to 30,000 g/mol, or 20,000 to 25,000 g/mol.

Embodiment 52. A dispersant comprising the homopolymer of embodiments 33-51. Embodiment 53. A process for preparing a neat homopolymer, said process comprising:
mixing in a reaction vessel, with heating and an inert atmosphere, a substituted or unsubstituted, unsaturated, conjugated aromatic monomer, a radical initiator, and a solvent, for a period of time sufficient to form a homopolymer;
obtaining the homopolymer in a solvent as a concentrate; and
removing the solvent under vacuum to obtain the neat homopolymer;
wherein homopolymer comprises structural units represented by a formula of embodiment 33.

Embodiment 54. A dispersant concentrate comprising at least one dispersant of embodiments 32 or 52 and at least one solvent.

Embodiment 55. The dispersant concentrate of embodiment 54, wherein the solvent is selected from the group consisting of N-methyl-2-pyrrolidone, water, toluene, xylene, isopropanol, ethyl acetate, butyl butyrate, and combinations thereof.

Embodiment 56. The dispersant concentrate of embodiment 54, wherein the dispersant is present in an amount from about 10 to about 80 wt %, or from about 20 to about 60 wt %, or from about 40 to about 60 wt %; and the solvent is present in an amount from about 20 to about 90 wt %, or from about 40 to about 80 wt %, or from about 40 to about 60 wt %, based on the total weight of the dispersant concentrate.

Embodiment 57. A conductive carbon dispersion comprising at least one dispersant of embodiments 32 or 52, or at least one dispersant concentrate of embodiments 54-56, at least one conductive carbon, and at least one solvent.

Embodiment 58. The conductive carbon dispersion of embodiment 57, wherein the conductive carbon is selected from the group consisting of carbon nanotubes, graphene, carbon black, graphite, and combinations thereof.

Embodiment 59. The conductive carbon dispersion of embodiment 57, wherein the dispersant or dispersant in dispersant concentrate is present in an amount from about 0.1 to about 6 wt %, or from about 0.1 to about 3 wt %, or from about 0.1 to about 1 wt %; the conductive carbon is present in an amount from about 0.5 to about 12 wt %, or from about 0.5 to about 4 wt %, or from about 0.5 to about 1 wt %; and the solvent is present in an amount from about 82 to about 99.5 wt %, or from about 82 to about 98 wt %, or from about 82 to about 95 wt %; based on the total weight of the conductive carbon dispersion.

Embodiment 60. The conductive carbon dispersion of embodiment 57 or 59, wherein the solvent is selected from the group consisting of N-methyl-2-pyrrolidone (NMP), water, toluene, xylene, isopropanol, ethyl acetate, butyl butyrate, and combinations thereof.

Embodiment 61. An electrode slurry composition for producing a battery positive electrode comprising at least one conductive carbon or conductive carbon dispersion of any one of embodiments 57-60, at least one electrode active material, and at least one binder.

Embodiment 62. The electrode slurry composition of embodiment 61, wherein the electrode active material is selected from the group consisting of lithium iron phosphate (LiFePO₄), lithium manganese iron phosphate (LiMnₓFe₍₁₋ₓ)PO₄), lithium cobalt oxide (LiCoO₂), lithium manganese oxide (LiMn₂O₄), lithium manganese oxide (Li₂MnO₃), lithium nickel manganese cobalt oxide (LiNi_{0.33}Mn_{0.33}Co_{0.33}O₂), lithium nickel manganese cobalt oxide (LiNi_{0.6}Mn_{0.2}Co_{0.2}O₂), and lithium nickel manganese cobalt oxide (LiNi_{0.8}Mn_{0.1}Co_{0.1}O₂).

Embodiment 63. The electrode slurry composition of embodiment 61, wherein the electrode active material is selected from the group consisting of a lithium oxide containing one or more metals selected from the group consisting of cobalt, manganese, nickel, and aluminum; a lithium oxide selected from the group consisting of a lithium-manganese-based oxide, LiMnO₂, and LiMn₂O; a lithium-cobalt-based oxide, and LiCoO₂; a lithium-nickel-based oxide and LiNiO₂; a lithium-nickel-manganese-based oxide, LiNi_{1-Y1}Mn_{Y1}O₂ wherein 0<Y1<1, LiNi_{Z1}Mn_{2-Z1}O4 wherein 0<Z1<2; a lithium-nickel-cobalt-based oxide, LiNi_{1-Y2}Co_{Y2}O₂ wherein 0<Y2<1; a lithium-manganese-cobalt-based oxide, LiCo_{1-Y3}Mn_{Y3}O₂ wherein 0<Y3<1, LiMn_{2-Z2}Co_{Z2}O₄ wherein 0<Z2<2; a lithium-nickel-cobalt-manganese-based oxide, Li(Ni_{P1}Co_{Q1}Mn_{R1})O₂ wherein 0<P1<1, 0<Q1<1, 0<R1<1, P1+Q1+R1=1, Li(Ni_{P2}Co_{Q2}Mn_{R2})O₄ wherein 0<P2<2, 0<Q2<2, 0<R2<2, P2+Q2+R2=2; and a lithium-nickel-cobalt-manganese-other metal (M) oxide, Li(Ni_{P3}Co_{Q3}Mn_{R3}M¹s)O₂ wherein M¹ is selected from the group consisting of Al, Cu, Fe, V, Cr, Ti, Zr, Zn, Ta, Nb, Mg, B, W and Mo, and P3, Q3, R3, and S are each an atomic fraction of independent elements, and 0<P3<1, 0<Q3<1, 0<R3<1, 0<S<1, P3+Q3+R3+S=1; and combinations thereof.

Embodiment 64. The electrode slurry composition of embodiment 61, wherein the binder is selected from the group consisting of polyvinylidene fluoride (PVDF), a vinylidene fluoride-hexafluoropropylene copolymer (PVDF-co-HFP), polyvinyl alcohol, polyacrylonitrile, carboxymethyl cellulose (CMC), starch, hydroxypropyl cellulose, regenerated cellulose, polyvinylpyrrolidone, polytetrafluoroethylene, polyethylene, polypropylene, an ethylene-propylene-diene monomer (EPDM), a sulfonated-EPDM, styrene-butadiene rubber (SBR), fluorine rubber, or copolymers thereof, and combinations thereof.

Embodiment 65. The electrode slurry composition of embodiment 61, wherein the electrode active material is lithium iron phosphate (LFP) and is present in an amount of about 100 parts by weight; the conductive carbon is present in an amount from about 0.2 to about 10 parts by weight, or from about 0.5 to about 2 parts by weight, or from about 0.5 to about 1.5 parts by weight; the dispersant is present in an amount from about 0.02 to about 0.5 parts by weight, or from about 0.05 to about 0.02 parts by weight, or from about 0.1 to about 0.2 parts by weight; the binder is present in an amount from about 0.5 to about 5 parts by weight, or from about 1.5 to about 2 parts by weight, or from about 0.5 to about 2 parts by weight; and the solvent is present in an amount from about 50 to about 75 parts by weight, or from about 55 to about 70 parts by weight, or from about 60 to about 65 parts by weight.

Embodiment 66. The electrode slurry composition of embodiment 61, wherein the electrode active material is lithium nickel manganese cobalt oxide (NMC) and is present in an amount of about 100 parts by weight, or from about 97 to 99 parts by weight, or from about 97 to about 98.3 parts by weight; the conductive carbon is carbon nanotubes and is present in an amount from about 0.2 to about 10 parts by weight, or from about 0.5 to about 2 parts by weight, or from about 0.5 to about 1.5 parts by weight; the dispersant is present in an amount from about 0.02 to about 0.5 parts by weight, or from about 0.1 to about 1 parts by weight, or from about 0.1 to about 0.25 parts by weight; the binder is present in an amount from about 0.5 to about 5 parts by weight, or from about 0.5 to about 1.5 parts by weight, or from about 0.5 to about 0.7 parts by weight; and the solvent is present in an amount from about 50 to about 75 parts by weight, or from about 55 to about 70 parts by weight, or from about 60 to about 65 parts by weight.

Embodiment 67. A positive electrode comprising an electrical current collector and a film formed on the electrical current collector, wherein the film is deposited from the electrode slurry composition of any one of embodiments 61-66, and the solvent subsequently removed.

Embodiment 68. An electrical storage device comprising the positive electrode of embodiment 67, a negative electrode, a separator, and an electrolyte.

Embodiment 69. The electrical storage device of embodiment 68 comprising a cell, a battery, a battery pack, a secondary battery, or a capacitor.

Embodiment 70. The dispersants of embodiments 32 and 52, when used in a conductive carbon dispersion, the conductive carbon dispersion exhibits lower viscosity and/or increased solids content, as compared to a control conductive carbon dispersion having polyvinyl pyrrolidone (PVP) dispersant.

Embodiment 71. The dispersants of embodiments 32 and 52, when used in a cathode slurry formulation, the cathode slurry formulation exhibits lower viscosity, as compared to a control cathode slurry formulation having polyvinyl pyrrolidone (PVP) dispersant, at high solid content.

Embodiment 72. The conductive carbon dispersion of embodiments 57-60 which has a viscosity (Pa·s) from about 1 to about 80 Pa·s, and a solids content (wt %) from about 0.5 to about 25 wt %, at a shear rate (l/s) from about 0.1 to about 100 l/s.

Embodiment 73. The electrode slurry composition of embodiments 61-66 which has a viscosity (Pa·s) from about 5 to about 30 Pa·s, and a solids content (wt %) from about 50 to about 80 wt %, at a shear rate (l/s) from about 0.1 to about 100 l/s.

### EXAMPLES

This disclosure may be further understood by reference to the following (non-limiting) examples. In the following Examples, the properties of certain components or the composition itself are described using certain terms of art, as defined below. In the Examples, all parts are parts by weight, unless otherwise noted.

CNT dispersions having different dispersants were prepared with a high-speed Silverson mixer with an emulsion workhead. The CNT dispersions contained the following ingredients: CNT 1.0%, dispersant 1.0%, NMP 98.0% by weight. The contents were mixed in ajar at 2000 rpm for 5 min, 4000 rpm for 5 min, 6000 rpm for 5 min, and 8000 rpm for 5 min. Rheology of the resulting CNT dispersions was measured with Anton Paar MCR 302e rheometer. The dispersants used in the CNT dispersions are shown in the Table E below.

TABLE E

| Dispersant | Chemical Description |
|---|---|
| 1 | Poly (acrylonitrile-co-2-naphthyl acrylate), |
| | acrylonitrile = 90 mol %, Mₙ = 15k |
| 2 | Poly(styrene-co-acrylonitrile), M_{w} = 165k, |
| | acrylonitrile = 25 wt % |
| 3 | Poly(dimethyl acrylamide-co-styrene), |
| | styrene = 70 mol %, Mₙ = 22k |
| 4 | Poly(4-vinylpyridine-co-styrene) |
| 5 (comparative | PVP: Polyvinylpyrrolidone K-30 |
| example 1) | |
| 6 | Poly (dimethyl acrylamide-co-2-naphthyl acrylate); |
| | dimethyl acrylamide = 30 mol %; Mₙ = 11k |
| 7 (comparative | Hydrogenated nitrile-butadiene rubber, |
| example 2) | acrylonitrile = 30%, Mₙ = 64k |
| 8 (inventive | Poly (acrylonitrile-co-2-naphthyl acrylate), |
| example) | acrylonitrile = 30 mol %, Mₙ = 17k |

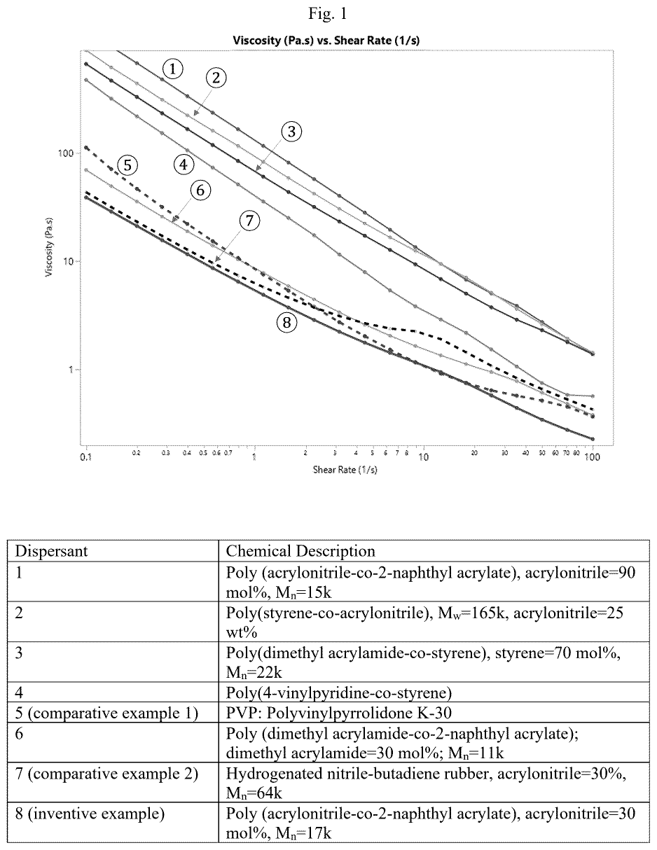

FIG. 1 graphically depicts a comparison of rheology of CNT dispersions using different dispersants in Table E, particularly viscosity relative to shear rate for comparative and inventive dispersants in Table E in CNT dispersions.

LFP cathode slurries having different dispersants were prepared with a centrifugal planetary Thinky mixer. The LFP cathode slurries contained the following ingredients: LFP 100 parts, PVDF 2 parts, carbon black (CB) 1.5 parts, dispersant 0.2 parts by weight, NMP is balanced to make a final slurry of 65% solid content (LFP+PVDF+CB+dispersant). PVDF, dispersant, and NMP were mixed at 2000 rpm for 2 min, then CB was added and mixed at 2000 rpm for 15 min. Finally LFP was added and mixed at 2000 rpm for 15 min to make LFP cathode slurry. Rheology of the resulting slurry was measured with Anton Paar MCR 302e rheometer. The dispersants used in the LFP cathode slurries are shown in the Table F below.

TABLE F

| Dispersant | Chemical Description |
|---|---|
| 1 | Lugalvan BNO12: Ethoxylated beta-Naphthol |
| 2 (comparative | No dispersant |
| example 1) | |
| 3 | Poly(4-vinylphenol), M_{w} = 25k |
| 4 | Poly(styrene-co-acrylonitrile), M_{w} = 165k, |
| | acrylonitrile 25 wt % |
| 5 (comparative | PVP: Polyvinylpyrrolidone K-30 |
| example 2) | |
| 6 (inventive | Poly(acrylonitrile-co-2-naphthyl acrylate), |
| example) | acrylonitrile 50 mol %, Mₙ = 21k |

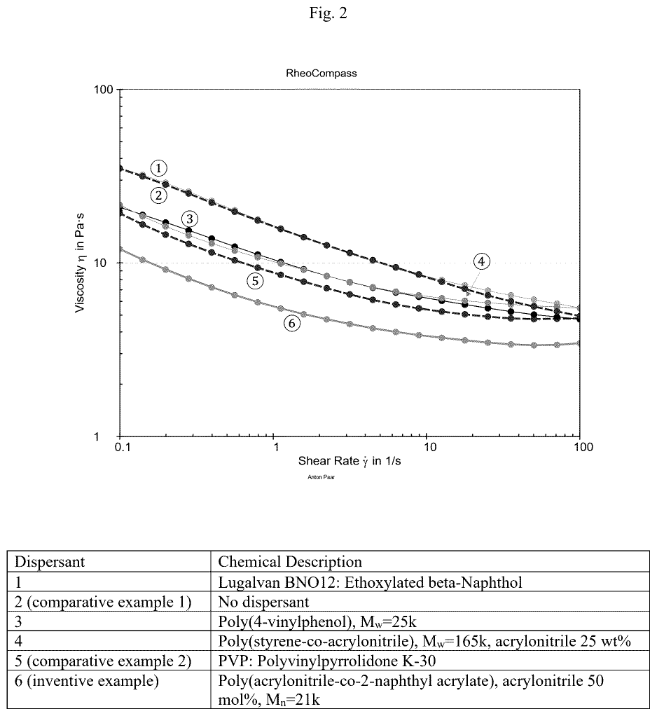

FIG. 2 graphically depicts a comparison of rheology of LFP cathode slurries using different dispersants in Table F, particularly viscosity relative to shear rate for comparative and inventive dispersants in Table F in LFP cathode slurries.

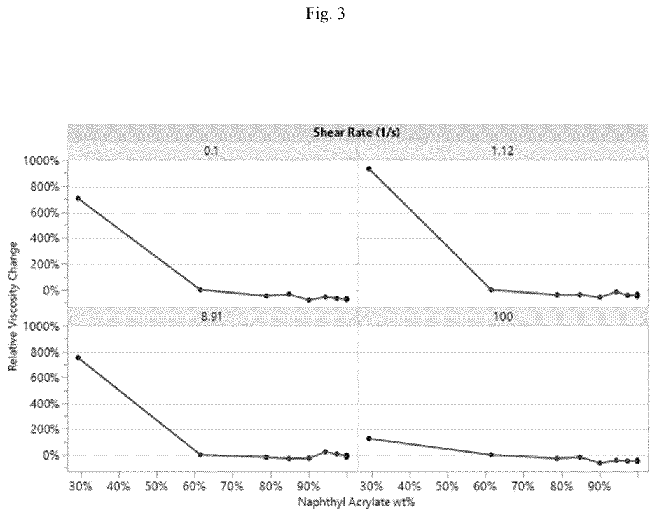

FIG. 3 graphically depicts additional plots from FIG. 1 of the viscosity change relative to shear rate with different dispersants in CNT dispersions, particularly relative viscosity change and mean relative viscosity change versus naphthyl acrylate wt % relative to shear rate. In particular, FIG. 3 shows viscosity change (in percentage) of CNT dispersions with naphthyl acrylate content (by weight %) in the dispersant polymer. Viscosity change % of CNT dispersion=(viscosity with candidate dispersant−viscosity with reference)/viscosity with reference×100%; reference=polymer with 60 wt % naphthyl acrylate). Shear rates were selected at 0.1, 1.12, 8.91, and 100 l/s.

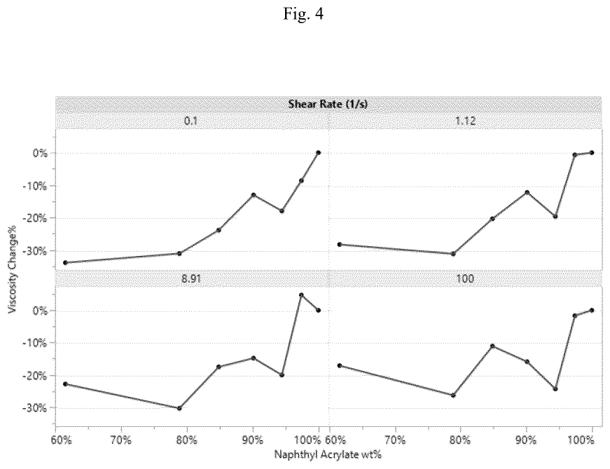

FIG. 4 graphically depicts additional plots from FIG. 2 of the viscosity change relative to shear rate with different dispersants in LFP cathode slurries, particularly viscosity change % versus naphthyl acrylate wt % relative to shear rate. In particular, FIG. 4 shows viscosity change (in percentage) of LFP slurry with naphthyl acrylate content (by weight %) in the dispersant polymer. Viscosity change % of LFP slurry=(viscosity with candidate dispersant−viscosity with reference)/viscosity with reference×100%; reference=polymer with 100 wt % Naphthyl Acrylate). Shear rates were selected at 0.1, 1.12, 8.91, and 100 l/s.

In the additional plots in FIGS. 3 and 4, one dispersant was selected as a reference, four shear rates were selected, and relative viscosity or viscosity change of dispersions or slurries (against naphthyl acrylate wt %) to reference was calculated.

In summary, it has been discovered that a family of poly(acrylonitrile-naphthyl acrylate) polymers can effectively disperse both CNTs and LFP active materials in a medium, which makes the instant disclosure an attractive way to make positive electrode slurries suitable for electrode coating. Surprisingly, the optimal monomer ratio was discovered to be different for CNTs versus LFP due to differences in the surface structure of their particles.

### Homopolymer Preparation

Naphthyl acrylate monomer and a radical initiator of specific ratio were mixed in solvent with heating to certain temperature under nitrogen purging for a period of time. The polymer was obtained in a solvent as a dispersant concentrate. Solvent was removed under vacuum to obtain neat polymer.

Method to make poly(naphthyl acrylate): Naphthyl acrylate (25.4 g, 128 mmol, 100 eqv) and V601 (0.157 g, 0.68 mmol, 0.53 eq) were dissolved in N-methyl pyrrolidone (NMP, 25.57 g) and purged with nitrogen for 30 minutes. The polymerization was left for 48 hours, with stirring, at 70° C. During this time, the reaction mixture became very viscous.

Method to make poly(4-vinylbenzyl naphthyl ether): 4-vinylbenzyl naphthyl ether monomer (5.0 g, 0.019 mol) was dissolved in 6 mL toluene under a dinitrogen atmosphere and the reaction temperature raised to 70° C. Initiator V601 (0.043 g, 1.9×10⁻⁴ mol in 2 mL toluene) was added dropwise and the mixture reacted for 30 hours. The toluene was removed under reduced pressure. The resulting solid was added to acetone and stirred for 5 minutes before the solid was filtered collected and dried to afford an off-white solid. 4.13 g, 83% yield.

### Copolymer Preparation

Naphthyl acrylate monomer and acrylonitrile and a radical initiator of specific molar ratio were mixed in solvent with heating to certain temperature under nitrogen purging for a period of time. The polymer was obtained in a solvent as a dispersant concentrate. Solvent was removed under vacuum to obtain neat polymer.

Naphthyl acrylate (17.76 g, 90 mmol, 70 eqv), acrylonitrile (2.11 g, 40 mmol, 30 eqv) and V601 (0.124 g, 0.54 mmol, 0.41 eq) were dissolved in N-methyl pyrrolidone (20.19 g) and purged with nitrogen for 30 minutes. The polymerization was left for 48 hours, with stirring, at 70° C. During this time, the reaction mixture became very viscous.

### PCT and EP Clauses

1. A copolymer comprising:
structural units comprising the residue of a substituted or unsubstituted, unsaturated organic nitrile monomer; and
structural units comprising the residue of a substituted or unsubstituted, unsaturated, conjugated aromatic monomer selected from the group consisting of a conjugated aromatic ester monomer, a conjugated aromatic ether monomer, a conjugated aromatic amide monomer, a conjugated aromatic alkylene monomer, and combinations thereof,
wherein the structural units comprising the residue of a substituted or unsubstituted, unsaturated, conjugated aromatic monomer are present in an amount from about 45 to about 99 wt %, and the structural units comprising the residue of the substituted or unsubstituted, unsaturated organic nitrile monomer are present in an amount from about 1 to about 55 wt %, based on the total weight of the copolymer.

2. The copolymer of clause 1 wherein the substituted or unsubstituted, unsaturated organic nitrile monomer is represented by the formula: R1

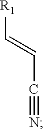

or by the formula:

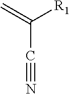

wherein R₁ is hydrogen or an alkyl group having from 1 to 10 carbon atoms; and wherein the substituted or unsubstituted, unsaturated, conjugated aromatic monomer is represented by the formula:

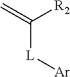

wherein R₂ is hydrogen or an alkyl group having from 1 to 10 carbon atoms; L is a linkage group selected from the group consisting of an ester linkage group, an ether linkage group, an amide linkage group, an alkylene linkage group; and any combination thereof; and Ar is a substituted or unsubstituted conjugated aromatic group having at least 1 aromatic ring; or
wherein the substituted or unsubstituted, unsaturated organic nitrile monomer is acrylonitrile monomer represented by the formula:

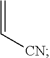

and
wherein the substituted or unsubstituted, unsaturated, conjugated aromatic monomer is 2-napthyl acrylate represented by the formula:

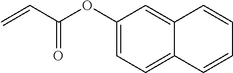

or 1-napthyl acrylate represented by the formula:

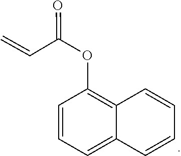

3. The copolymer of clause 2 wherein the ester linkage group is represented by the formula:

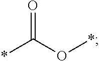

wherein the ether linkage group is represented by the formula selected from the group consisting of:

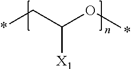

wherein X₁ is hydrogen, or an alkyl group having from 1 to 10 carbon atoms, or an alkyl group having from 1 to 8 carbon atoms, or an alkyl group having from 1 to 6 carbon atoms, or an alkyl group having from 1 to 4 carbon atoms, or an alkyl group having 1 or 2 carbon atoms, or a methyl group; and n is a value from 0 to 24, or a value from 0 to 20, or a value from 0 to 15, or a value from 0 to 10, or a value from 0 to 5;

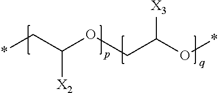

wherein X₂ and X₃ are independently hydrogen or an alkyl group having from 1 to 10 carbon atoms, or an alkyl group having from 1 to 8 carbon atoms, or an alkyl group having from 1 to 6 carbon atoms, or an alkyl group having from 1 to 4 carbon atoms, or an alkyl group having 1 or 2 carbon atoms, or a methyl group; and p and q are independently a value from 0 to 24, or a value from 0 to 20, or a value from 0 to 15, or a value from 0 to 10, or a value from 0 to 5;

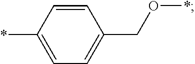

and any combination thereof,

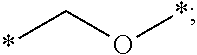

wherein the amide linkage group is represented by the formula selected from the group consisting of:

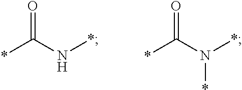

and
a combination thereof, and
wherein the alkylene linkage group is represented by the formula:

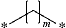

wherein m is a value from 1 to 10, or a value from 1 to 8, or a value from 1 to 6, or a value from 1 to 4, or a value from 1 to 2.

4. The copolymer of clause 2 wherein Ar is represented by the formula selected from the group consisting of:

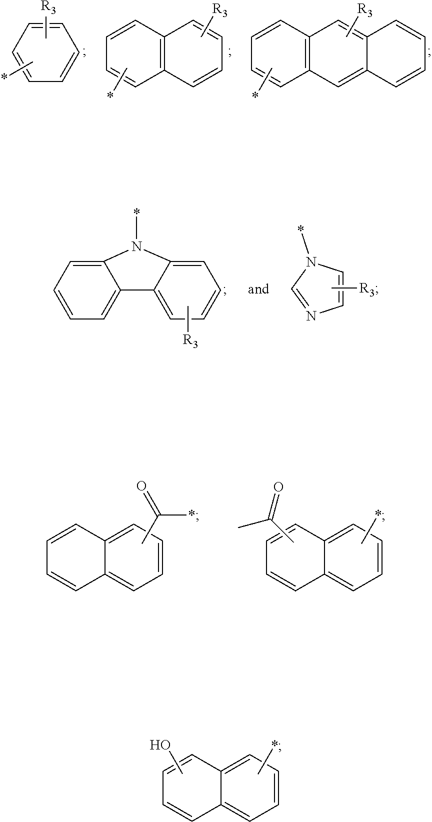

wherein R₃ is hydrogen or an alkyl group having from 1 to 10 carbon atoms, or an alkyl group having from 1 to 8 carbon atoms, or an alkyl group having from 1 to 6 carbon atoms, or an alkyl group having from 1 to 4 carbon atoms, or an alkyl group having 1 or 2 carbon atoms, or a methyl group.

5. The copolymer of clause 1 which is represented by the formula:

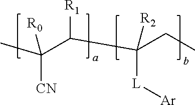

wherein R₀, R₁ and R₂ are independently hydrogen or an alkyl group having from 1 to 10 carbon atoms; L is a linkage group selected from the group consisting of an ester linkage group, an ether linkage group, an amide linkage group, an alkylene linkage group, and any combination thereof; Ar is a substituted or unsubstituted conjugated aromatic group having at least 1 aromatic ring; a is a value from about 10 to about 200; and b is a value from about 10 to about 200; or which is poly(acrylonitrile 2-napthyl acrylate) (PANA) represented by the formula:

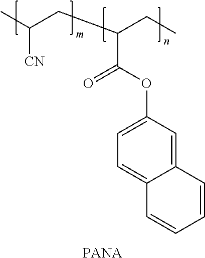

or a poly(acrylonitrile 1-napthyl acrylate) represented by the formula:

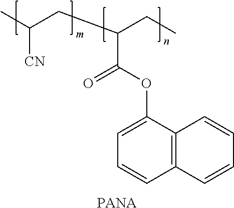

wherein m has a value from 10 to about 200, and n has a value from about 10 to about 200.

6. The copolymer of clause 1 wherein the structural units comprising the residue of the substituted or unsubstituted, unsaturated organic nitrile monomer are present in an amount from about 1 wt % to about 55 wt %, 1 wt % to about 50 wt %, or from about 1 wt % to about 45 wt %, or from about 1 wt % to about 40 wt %, or from about 1 wt % to about 35 wt %, or from about 1 wt % to about 30 wt %, or from about 1 wt % to about 25 wt %, or from about 1 wt % to about 20 wt %, or from about 1 wt % to about 15 wt %, or from about 1 wt % to about 10 wt/o, or from about 1 wt % to about 5 wt %, based on the total weight of the copolymer; and wherein the structural units comprising the residue of the substituted or unsubstituted, unsaturated, conjugated aromatic monomer are present in an amount from about 45 wt % to about 99 wt/o, 50 wt % to about 99 wt %, or from about 55 wt % to about 99 wt %, or from about 60 wt % to about 99 wt %, or from about 65 wt % to about 99 wt %, or from about 70 wt % to about 99 wt %, or from about 75 wt % to about 99 wt %, or from about 80 wt % to about 99 wt %, or from about 85 wt % to about 99 wt %, or from about 90 wt % to about 99 wt %, based on the total weight of the copolymer.

7. The copolymer of clause 1 which has a weight average molecular weight of 2,500 to 400,000 g/mol, or 2,500 to 300000 g/mol, or 2,500 to 200,000 g/mol, or 2,500 to 100,000 g/mol, or 2,500 to 75,000 g/mol, or 2,500 to 50,000 g/mol, or 2,500 to 25,500 g/mol, or 2,500 to 10,000 g/mol, or 2.500 to 7,500 g/mol, or 5,000 to 400,000 g/mol, or 5,000 to 300,000 g/mol, or 5,000 to 200,000 g/mol, or 5,000 to 100,000 g/mol, or 5,000 to 75,000 g/mol, or 5,000 to 50,000 g/mol, or 5,000 to 25,000 g/mol, or 5,000 to 12,500 g/mol, or 5,000 to 10,000 g/mol, or 5,000 to 7.500 g/mol, or 7,500 to 400,000 g/mol, or 7,500 to 300,000 g/mol, or 7,500 to 200,000 g/mol, or 7,500 to 100,000 g/mol, or 7,500 to 75,000 g/mol, or 7,500 to 50,000 g/mol, or 7,500 to 25,000 g/mol, or 7,500 to 15,000 g/mol, or 7,500 to 12,500 g/mol, or 7,500 to 10,000 g/mol, or 10,000 to 400,000 g/mol, or 10,000 to 300,000 g/mol, or 10,000 to 200,000 g/mol, or 10,000 to 100,000 g/mol, or 10,000 to 75,000 g/mol, or 10,000 to 50,000 g/mol, or 10,000 to 25,000 g/mol, or 10,000 to 12,500 g/mol; or which has a number average molecular weight of 5,000 to 200,000 g/mol, or 5,000 to 150,000 g/mol, or 5,000 to 100,000 g/mol, or 5,000 to 50,000 g/mol, or 5,000 to 40,000 g/mol, or 5,000 to 30,000 g/mol, or 5,000 to 25,000 g/mol, or 5,000 to 20,000 g/mol, or 5,000 to 15,000 g/mol, or 10,000 to 200,000 g/mol, or 10,000 to 150,000 g/mol, or 10,000 to 100,000 g/mol, or 10,000 to 50,000 g/mol, or 10,000 to 40,000 g/mol, or 10,000 to 30,000 g/mol, or 10,000 to 25,000 g/mol, or 10,000 to 20,000 g/mol, or 10,000 to 15,000 g/mol, or 15,000 to 200,000 g/mol, or 15,000 to 150,000 g/mol, or 15,000 to 100,000 g/mol, or 15,000 to 50,000 g/mol, or 15,000 to 40,000 g/mol, or 15,000 to 30,000 g/mol, or 15,000 to 25,000 g/mol, or 15,000 to 20,000 g/mol, or 20,000 to 200,000 g/mol, or 20,000 to 150,000 g/mol, or 20,000 to 100,000 g/mol, or 20,000 to 50,000 g/mol, or 20,000 to 40,000 g/mol, or 20,000 to 30,000 g/mol, or 20,000 to 25,000 g/mol.

8. A homopolymer having structural units represented by the formula:

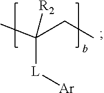

or by the formula

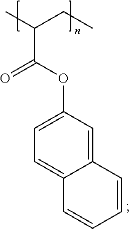

or by the formula:

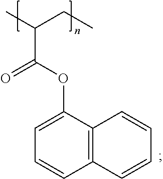

wherein R₂ is hydrogen or an alkyl group having from 1 to 10 carbon atoms; L is a linkage group selected from the group consisting of an ester linkage group, an ether linkage group, an amide linkage group, an alkylene linkage group, and any combination thereof; Ar is a substituted or unsubstituted conjugated aromatic group having at least 1 aromatic ring; and b and n are independently a value from about 10 to about 400; and wherein the ether linkage group is other than the ether linkage group represented by the formula:

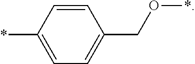

9. A dispersant comprising the copolymer of clause 1; or the homopolymer of clause 8.

10. The homopolymer of clause 8 which has a weight average molecular weight of 2,500 to 400,000 g/mol, or 2,500 to 300,000 g/mol, or 2,500 to 200,000 g/mol, or 2,500 to 100,000 g/mol, or 2,500 to 75,000 g/mol, or 2,500 to 50,000 g/mol, or 2,500 to 25,500 g/mol, or 2,500 to 10,000 g/mol, or 2.500 to 7,500 g/mol, or 5,000 to 400,000 g/mol, or 5,000 to 300,000 g/mol, or 5,000 to 200,000 g/mol, or 5,000 to 100,000 g/mol, or 5,000 to 75,000 g/mol, or 5,000 to 50,000 g/mol, or 5,000 to 25,000 g/mol, or 5,000 to 12,500 g/mol, or 5,000 to 10,000 g/mol, or 5,000 to 7.500 g/mol, or 7,500 to 400,000 g/mol, or 7,500 to 300,000 g/mol, or 7,500 to 200,000 g/mol, or 7,500 to 100,000 g/mol, or 7,500 to 75,000 g/mol, or 7,500 to 50,000 g/mol, or 7,500 to 25,000 g/mol, or 7,500 to 15,000 g/mol, or 7,500 to 12,500 g/mol, or 7,500 to 10,000 g/mol, or 10,000 to 400,000 g/mol, or 10,000 to 300,000 g/mol, or 10,000 to 200,000 g/mol, or 10,000 to 100,000 g/mol, or 10,000 to 75,000 g/mol, or 10,000 to 50,000 g/mol, or 10,000 to 25,000 g/mol, or 10,000 to 12,500 g/mol; or which has a number average molecular weight of 5,000 to 200,000 g/mol, or 5,000 to 150,000 g/mol, or 5,000 to 100,000 g/mol, or 5,000 to 50,000 g/mol, or 5,000 to 40,000 g/mol, or 5,000 to 30,000 g/mol, or 5,000 to 25,000 g/mol, or 5,000 to 20,000 g/mol, or 5,000 to 15,000 g/mol, or 10,000 to 200,000 g/mol, or 10,000 to 150,000 g/mol, or 10,000 to 100,000 g/mol, or 10,000 to 50,000 g/mol, or 10,000 to 40,000 g/mol, or 10,000 to 30,000 g/mol, or 10,000 to 25,000 g/mol, or 10,000 to 20,000 g/mol, or 10,000 to 15,000 g/mol, or 15,000 to 200,000 g/mol, or 15,000 to 150,000 g/mol, or 15,000 to 100,000 g/mol, or 15,000 to 50,000 g/mol, or 15,000 to 40,000 g/mol, or 15,000 to 30,000 g/mol, or 15,000 to 25,000 g/mol, or 15,000 to 20,000 g/mol, or 20,000 to 200,000 g/mol, or 20,000 to 150,000 g/mol, or 20,000 to 100,000 g/mol, or 20,000 to 50,000 g/mol, or 20,000 to 40,000 g/mol, or 20,000 to 30,000 g/mol, or 20,000 to 25,000 g/mol.

11. A dispersant concentrate comprising at least one dispersant of clause 9, and at least one solvent.

12. The dispersant concentrate of clause 11, wherein the dispersant is present in an amount from about 10 to about 80 wt %, or from about 20 to about 60 wt %, or from about 40 to about 60 wt %; and the solvent is selected from the group consisting of N-methyl-2-pyrrolidone, water, toluene, xylene, isopropanol, ethyl acetate, butyl butyrate, and combinations thereof, and is present in an amount from about 20 to about 90 wt %, or from about 40 to about 80 wt %, or from about 40 to about 60 wt %, based on the total weight of the dispersant concentrate.

13. A conductive carbon dispersion comprising at least one dispersant of clause 9, or at least one dispersant concentrate of clauses 11 and 12, at least one conductive carbon, and at least one solvent.

14. The conductive carbon dispersion of clause 13, wherein the conductive carbon is selected from the group consisting of carbon nanotubes, graphene, carbon black, graphite, and combinations thereof.

15. The conductive carbon dispersion of clauses 13 and 14, wherein the dispersant or dispersant in dispersant concentrate is present in an amount from about 0.1 to about 6 wt %, or from about 0.1 to about 3 wt %, or from about 0.1 to about 1 wt %; the conductive carbon is present in an amount from about 0.5 to about 12 wt %, or from about 0.5 to about 4 wt %, or from about 0.5 to about 1 wt %; and the solvent is selected from the group consisting of N-methyl-2-pyrrolidone, water, toluene, xylene, isopropanol, ethyl acetate, butyl butyrate, and combinations thereof, and is present in an amount from about 82 to about 99.5 wt %, or from about 82 to about 98 wt %, or from about 82 to about 95 wt %; based on the total weight of the conductive carbon dispersion.

16. An electrode slurry composition for producing a battery positive electrode comprising at least one conductive carbon or conductive carbon in dispersion of any one of clauses 13-15, at least one electrode active material, and at least one binder.

17. The electrode slurry composition of clause 16, wherein the electrode active material is selected from the group consisting of lithium iron phosphate (LiFePO₄), lithium manganese iron phosphate (LiMnₓFe₍₁₋ₓ₎PO₄), lithium cobalt oxide (LiCoO₂), lithium manganese oxide (LiMn₂O₄), lithium manganese oxide (Li₂MnO₃), lithium nickel manganese cobalt oxide (LiNi_{0.33}Mn_{0.33}Co_{0.33}O₂), lithium nickel manganese cobalt oxide (LiNi_{0.6}Mn_{0.2}Co_{0.2}O₂), and lithium nickel manganese cobalt oxide (LiNi_{0.8}Mn_{0.1}Co_{0.1}O₂); and wherein the binder is selected from the group consisting of polyvinylidene fluoride (PVDF), a vinylidene fluoride-hexafluoropropylene copolymer (PVDF-co-HFP), polyvinyl alcohol, polyacrylonitrile, carboxymethyl cellulose (CMC), starch, hydroxypropyl cellulose, regenerated cellulose, polyvinylpyrrolidone, polytetrafluoroethylene, polyethylene, polypropylene, an ethylene-propylene-diene monomer (EPDM), a sulfonated-EPDM, styrene-butadiene rubber (SBR), fluorine rubber, or copolymers thereof, and combinations thereof.

18. A positive electrode comprising an electrical current collector and a film formed on the electrical current collector, wherein the film is deposited from the electrode slurry composition of any one of clauses 16 and 17, and the solvent subsequently removed.

19. An electrical storage device comprising the positive electrode of clause 18, a negative electrode, a separator, and an electrolyte; or comprising a cell, a battery, a battery pack, a secondary battery, or a capacitor.

20. The conductive carbon dispersion of clauses 13-15 which has a viscosity (Pa·s) from about 1 to about 80 Pa·s, and a solids content (wt %) from about 0.5 to about 25 wt %, at a shear rate (l/s) from about 0.1 to about 100 l/s; or the electrode slurry composition of clauses 15 and 16 which has a viscosity (Pa·s) from about 5 to about 30 Pa·s, and a solids content (wt %) from about 50 to about 80 wt %, at a shear rate (l/s) from about 0.1 to about 100 l/s.

21. A process for preparing the copolymer of clause 1, said process comprising mixing in a reaction vessel, with heating and an inert atmosphere, a substituted or unsubstituted, unsaturated organic nitrile monomer, a substituted or unsubstituted, unsaturated, conjugated aromatic monomer, a radical initiator, and a solvent, for a period of time sufficient to form said copolymer; optionally obtaining the copolymer in a solvent as a concentrate; and optionally removing the solvent under vacuum to obtain a neat copolymer.

22. A process for preparing the homopolymer of clause 8, said process comprising mixing in a reaction vessel, with heating and an inert atmosphere, a substituted or unsubstituted, unsaturated, conjugated aromatic monomer, a radical initiator, and a solvent, for a period of time sufficient to form the homopolymer; optionally obtaining the homopolymer in a solvent as a concentrate; and optionally removing the solvent under vacuum to obtain a neat homopolymer.

The disclosures of all patents, articles and other materials described herein are hereby incorporated, in their entirety, into this specification by reference. A description of a composition comprising, consisting of, or consisting essentially of multiple specified components, as presented herein and in the appended claims, should be construed to also encompass compositions made by admixing said multiple specified components. The principles, preferred embodiments, and modes of operation of the present disclosure have been described in the foregoing specification. What applicants submit is their disclosure, however, is not to be construed as limited to the particular embodiments disclosed, since the disclosed embodiments are regarded as illustrative rather than limiting. Changes may be made by those skilled in the art without departing from the spirit of the disclosure.

What is claimed is:

1. A copolymer comprising:
structural units comprising the residue of a substituted or unsubstituted, unsaturated organic nitrile monomer; and
structural units comprising the residue of a substituted or unsubstituted, unsaturated, conjugated aromatic monomer selected from the group consisting of a conjugated aromatic ester monomer, a conjugated aromatic ether monomer, a conjugated aromatic amide monomer, a conjugated aromatic alkylene monomer, and combinations thereof,
wherein the structural units comprising the residue of a substituted or unsubstituted, unsaturated, conjugated aromatic monomer are present in an amount from about 45 to about 99 wt %, and the structural units comprising the residue of the substituted or unsubstituted, unsaturated organic nitrile monomer are present in an amount from about 1 to about 55 wt %, based on the total weight of the copolymer.

2. The copolymer of claim 1 which is in the form of a block copolymer, a random copolymer, or a gradient copolymer.

3. The copolymer of claim 1 wherein the substituted or unsubstituted, unsaturated organic nitrile monomer is represented by the formula: 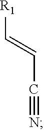
or by the formula: 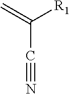
wherein R₁ is hydrogen or an alkyl group having from 1 to 10 carbon atoms.

4. The copolymer of claim 1 wherein the substituted or unsubstituted, unsaturated, conjugated aromatic monomer is represented by the formula: 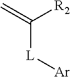
wherein R₂ is hydrogen or an alkyl group having from 1 to 10 carbon atoms; L is a linkage group selected from the group consisting of an ester linkage group, an ether linkage group, an amide linkage group, an alkylene linkage group; and any combination thereof; and Ar is a substituted or unsubstituted conjugated aromatic group having at least 1 aromatic ring.

5. The copolymer of claim 4 wherein the ester linkage group is represented by the formula: 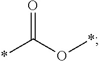
wherein the ether linkage group is represented by the formula selected from the group consisting of: 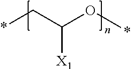
wherein X₁ is hydrogen or an alkyl group having from 1 to 10 carbon atoms; and n is a value from 0 to 24; 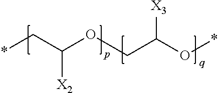
wherein X₂ and X₃ are independently hydrogen or an alkyl group having from 1 to 10 carbon atoms; and p and q are independently a value from 0 to 24; 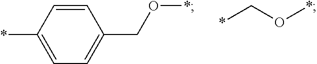
and any combination thereof,
wherein the amide linkage group is represented by the formula selected from the group consisting of: 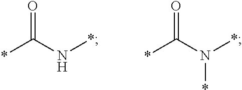
and
any combination thereof, and
wherein the alkylene linkage group is represented by the formula: 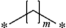
wherein m is a value from 1 to 10.

6. The copolymer of claim 4 wherein Ar is represented by the formula selected from the group consisting of: 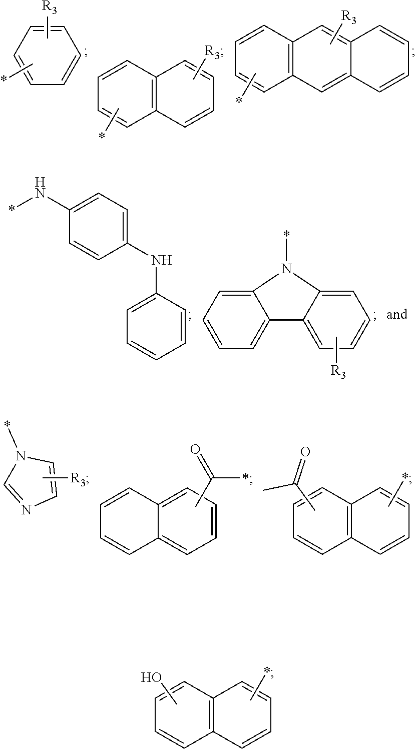
wherein R₃ is hydrogen or an alkyl group having from 1 to 10 carbon atoms.

7. The copolymer of claim 1 which is represented by the formula: 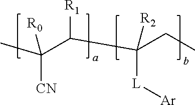
wherein R₀, R₁ and R₂ are independently hydrogen or an alkyl group having from 1 to 10 carbon atoms; L is a linkage group selected from the group consisting of an ester linkage group, an ether linkage group, an amide linkage group, an alkylene linkage group, and any combination thereof; Ar is a substituted or unsubstituted conjugated aromatic group having at least 1 aromatic ring; a is a value from about 10 to about 200; and b is a value from about 10 to about 200.

8. The copolymer of claim 1 wherein the substituted or unsubstituted, unsaturated organic nitrile monomer is acrylonitrile monomer represented by the formula: 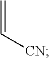
and
wherein the substituted or unsubstituted, unsaturated, conjugated aromatic monomer is 2-napthyl acrylate represented by the formula: 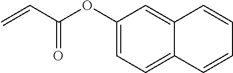
or 1-napthyl acrylate represented by the formula:

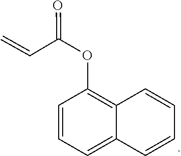

9. The copolymer of claim 1 which is poly(acrylonitrile 2-napthyl acrylate) (PANA) represented by the formula: 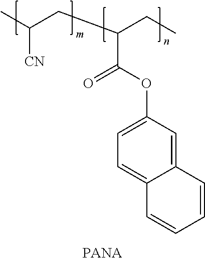
or a poly(acrylonitrile 1-napthyl acrylate) represented by the formula: 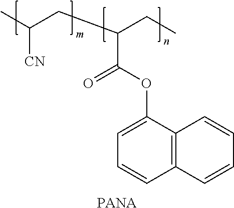
wherein m has a value from 10 to about 200, and n has a value from about 10 to about 200.

10. The copolymer of claim 1 wherein the structural units comprising the residue of the substituted or unsubstituted, unsaturated organic nitrile monomer are present in an amount from about 1 wt % to about 50 wt %, based on the total weight of the copolymer; and wherein the structural units comprising the residue of the substituted or unsubstituted, unsaturated, conjugated aromatic monomer are present in an amount from about 50 wt % to about 99 wt %, based on the total weight of the copolymer.

11. The copolymer of claim 1 wherein the weight ratio of the structural units comprising the residue of the substituted or unsubstituted, unsaturated organic nitrile monomer to the structural units comprising the residue of the substituted or unsubstituted, unsaturated, conjugated aromatic monomer in the copolymer is from about 1:99 to about 55:45.

12. The copolymer of claim 1 which has a weight average molecular weight of 2,500 to 400,000 g/mol, or a number average molecular weight of 5,000 to 200,000 g/mol.

13. A homopolymer having structural units represented by the formula: 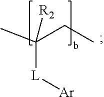
or by the formula 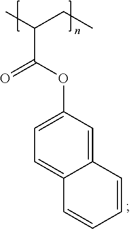
or by the formula: 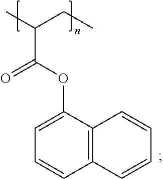
wherein R₂ is hydrogen or an alkyl group having from 1 to 10 carbon atoms; L is a linkage group selected from the group consisting of an ester linkage group, an ether linkage group, an amide linkage group, an alkylene linkage group, and any combination thereof; Ar is a substituted or unsubstituted conjugated aromatic group having at least 1 aromatic ring; and b and n are independently a value from about 10 to about 400; and wherein the ether linkage group is other than the ether linkage group represented by the formula:

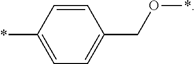

14. A dispersant comprising the copolymer of claim 1.

15. The homopolymer of claim 13 which has a weight average molecular weight of 2,500 to 400,000 g/mol, or a number average molecular weight of 5,000 to 200,000 g/mol.

16. A dispersant concentrate comprising at least one dispersant of claim 14, and at least one solvent.

17. The dispersant concentrate of claim 16, wherein the solvent is selected from the group consisting of N-methyl-2-pyrrolidone, water, toluene, xylene, isopropanol, ethyl acetate, butyl butyrate, and combinations thereof.

18. The dispersant concentrate of claim 16, wherein the dispersant is present in an amount from about 10 to about 80 wt %, based on the total weight of the dispersant concentrate.

19. A conductive carbon dispersion comprising at least one dispersant of claim 14, at least one conductive carbon, and at least one solvent.

20. A conductive carbon dispersion at least one dispersant concentrate of claim 16, at least one conductive carbon, and at least one solvent.

21. The conductive carbon dispersion of claim 19, wherein the conductive carbon is selected from the group consisting of carbon nanotubes, graphene, carbon black, graphite, and combinations thereof.

22. The conductive carbon dispersion of claim 19, wherein the dispersant or dispersant concentrate is present in an amount from about 0.1 to about 6 wt %; and the solvent is present in an amount from about 82 to about 99.5 wt %; based on the total weight of the conductive carbon dispersion.

23. The conductive carbon dispersion of claim 19, wherein the solvent is selected from the group consisting of N-methyl-2-pyrrolidone, water, toluene, xylene, isopropanol, ethyl acetate, butyl butyrate, and combinations thereof.

24. An electrode slurry composition for producing a battery positive electrode comprising at least one conductive carbon dispersion of claim 19, at least one electrode active material, and at least one binder.

25. The electrode slurry composition of claim 24, wherein the electrode active material is selected from the group consisting of lithium iron phosphate (LiFePO₄), lithium manganese iron phosphate (LiMnₓFe₍₁₋ₓ₎PO₄), lithium cobalt oxide (LiCoO₂), lithium manganese oxide (LiMn₂O₄), lithium manganese oxide (Li₂MnO₃), lithium nickel manganese cobalt oxide (LiNi_{0.33}Mn_{0.33}Co_{0.33}O₂), lithium nickel manganese cobalt oxide (LiNi_{0.6}Mn_{0.2}Co_{0.2}O₂), and lithium nickel manganese cobalt oxide (LiNi_{0.8}Mn_{0.1}Co_{0.1}O₂).

26. The electrode slurry composition of claim 24, wherein the binder is selected from the group consisting of polyvinylidene fluoride (PVDF), a vinylidene fluoride-hexafluoropropylene copolymer (PVDF-co-HFP), polyvinyl alcohol, polyacrylonitrile, carboxymethyl cellulose (CMC), starch, hydroxypropyl cellulose, regenerated cellulose, polyvinylpyrrolidone, polytetrafluoroethylene, polyethylene, polypropylene, an ethylene-propylene-diene monomer (EPDM), a sulfonated-EPDM, styrene-butadiene rubber (SBR), fluorine rubber, or copolymers thereof, and combinations thereof.

27. A positive electrode comprising an electrical current collector and a film formed on the electrical current collector, wherein the film is deposited from the electrode slurry composition of claim 23, and the solvent subsequently removed.

28. An electrical storage device comprising the positive electrode of claim 27, a negative electrode, a separator, and an electrolyte.

29. The electrical storage device of claim 28 comprising a cell, a battery, a battery pack, a secondary battery, or a capacitor.

30. The conductive carbon dispersion of claim 19 which has a viscosity (Pa·s) from about 1 to about 80 Pa·s, and a solids content (wt %) from about 0.5 to about 25 wt %, at a shear rate (l/s) from about 0.1 to about 100 l/s; and which exhibits lower viscosity and/or increased solids content, as compared to a control conductive carbon dispersion having polyvinyl pyrrolidone (PVP) dispersant.

31. The electrode slurry composition of claim 24 which has a viscosity (Pa·s) from about 5 to about 30 Pa·s, and a solids content (wt %) from about 50 to about 80 wt %, at a shear rate (l/s) from about 0.1 to about 100 l/s; and which exhibits lower viscosity, as compared to a control electrode slurry formulation having polyvinyl pyrrolidone (PVP) dispersant, at high solid content.

32. A process for preparing the copolymer of claim 1, said process comprising mixing in a reaction vessel, with heating and an inert atmosphere, a substituted or unsubstituted, unsaturated organic nitrile monomer, a substituted or unsubstituted, unsaturated, conjugated aromatic monomer, a radical initiator, and a solvent, for a period of time sufficient to form said copolymer; optionally obtaining the copolymer in a solvent as a concentrate; and optionally removing the solvent under vacuum to obtain a neat copolymer.

33. A process for preparing the homopolymer of claim 13, said process comprising mixing in a reaction vessel, with heating and an inert atmosphere, a substituted or unsubstituted, unsaturated, conjugated aromatic monomer, a radical initiator, and a solvent, for a period of time sufficient to form the homopolymer; optionally obtaining the homopolymer in a solvent as a concentrate; and optionally removing the solvent under vacuum to obtain a neat homopolymer.

34. A dispersant comprising the homopolymer of claim 13.
